(19) United States
(12) Patent Application Publication
(10) Pub. No.: US 2012/0187686 A1
(43) Pub. Date: Jul. 26, 2012

(54) HYDROELECTRIC GENERATORS

(76) Inventor: Randal D. Walton, Reno, NV (US)

(21) Appl. No.: 13/037,711

(22) Filed: Mar. 1, 2011

Related U.S. Application Data
(63) Continuation-in-part of application No. 13/011,828, filed on Jan. 21, 2011.

(51) Int. Cl. F03B 13/08

(52) U.S. Cl. 290/52

(57) ABSTRACT

Hydroelectric generators, including liquid sources containing liquid, siphons extending from a first end positioned within the liquid source to a second end at a lower elevation than the first end, and generation units configured to receive liquid from the siphon pipe, either directly or through an intermediary collection body. The siphons including siphon pipes, including input segments proximate the first end defining an input opening within the liquid source, discharge segments proximate the second end defining an output opening, and elevated segments extending between the input segments and the discharge segments with a portion of their length above the first ends and the second ends.

### CROSS-REFERENCE TO RELATED APPLICATION

This is a continuation-in-part of copending application Ser. No. 13/011,828 filed on Jan. 21, 2011, which is hereby incorporated by reference.

### BACKGROUND

The present disclosure relates generally to hydroelectric generators. In particular, hydroelectric generators that provide efficiency gains through the accumulation of a potential energy within a fluid in a collecting body prior to communicating the fluid to a generation unit including a turbine and generator. Such efficiency gains are particularly suited to contexts in which a fluid input's potential energy would otherwise be insufficient to power a hydroelectric generator.

In particular, such hydroelectric generators may be particularly suited to collect liquid waste routed through storm water and sewage disposal systems. Fluid from such systems may be harnessed: within structures wherein the liquid waste and storm water are collected and within community liquid waste sewage systems. Implementing a collection body to accumulate a potential energy is beneficial in such contexts due to the variance in flow levels inherent in these systems.

Hydroelectric generators that accumulate potential energy within a collection body may also be useful in contexts with upstream generators, particularly those located within hydroelectric dams. Accumulating liquid output from either a dam or spillway attached to the dam and releasing it more efficiently harnesses potential energy from these sources than would otherwise be underutilized.

Turbines within hydroelectric generators provide an additional opportunity to accumulate potential energy within a liquid body. Specifically, vertically arranged turbines may be designed with collection bodies within the turbines' blades, wherein the turbines are configured to rotate only after a selected quantity of liquid has been collected between the blades. Such a design may be useful in the low flow contexts described above.

The resent disclosure additionally relates to various hydroelectric generators designs, wherein the generators are arranged in series in a plural, cascaded arrangement. Such hydroelectric generators provide efficiency gains by utilizing a fluid's potential energy as it cascades over a plurality of generators in series rather than to power a solitary generator.

Using liquid waste for hydroelectricity creates a need for a means of breaking up solid waste sometimes communicated along with the liquid waste.

### SUMMARY

The present disclosure is directed to hydroelectric generators addressing the needs described in the above Background. Specifically, examples of hydroelectric generators that harness underutilized liquid sources are provided. Several examples implementing cascading systems are provided, wherein a plurality of generators are used in series maximize the generation of electricity hydroelectric generators. While this disclosure discusses designs outside of any particular context, this disclosure also specifically describes examples of such systems implemented within liquid waste disposal systems and hydroelectric dam contexts.

Additionally, this disclosure provides examples of hydroelectric generators that accumulate potential energy within a liquid collected by a collection body prior to communicating the liquid to a generator. Such hydroelectric generators are designed to harness the potential energy of liquid source from low flow sources that would otherwise be underutilized. This disclosure provides examples of hydroelectric generators that harness potential energy in various ways, including by implementing collection bodies that define funnels and pipes in fluid communication with a generator and by implementing collection bodies between the blades of vertically oriented turbines.

In addition to the examples described above, this disclosure discusses approaches to minimizing the potential for harm that solid waste may introduce into hydroelectric generator systems. Specifically, this disclosure contemplates solid waste dispersal members that are designed to move about the collection bodies. This disclosure additionally contemplates a means for powering the movement of these waste dispersal members by the same liquid source used to power the downstream generator.

### BRIEF DESCRIPTION OF THE DRAWINGS

FIG. 1 is a side elevation view of a first example of a hydroelectric generator.

FIG. 2 is a perspective view of the hydroelectric generator shown in FIG. 1.

FIG. 3 is a perspective view of the hydroelectric generator shown in FIG. 1 implementing a hydroelectric generator's output as a liquid source.

FIG. 4 is a perspective view of a second example of a hydroelectric generator that includes a first cascaded generation unit and a second cascaded generation unit that uses the first cascaded generation output as a liquid source.

FIG. 5 is a side elevation view of a third example of a hydroelectric generator wherein water collects between a collection of turbine blades to apply torque to a turbine.

FIG. 6 is a side elevation view of a fourth example of a hydroelectric generator including three vertically organized turbines arranged with substantially alternating orientations.

FIG. 7 is a side elevation view of a fourth example of a hydroelectric generator including three vertically organized turbines arranged with similar orientations.

FIG. 8 is a side elevation view of a fifth example of a hydroelectric generator wherein the output of the hydroelectric generator shown in FIG. 6 is routed to the input of the hydroelectric generator shown in FIG. 1.

FIG. 9 is a perspective view of a sixth example of a hydroelectric generator wherein storm water and sewage disposal systems within a building rotate a collection of turbines and generators.

FIG. 10 is a perspective view of the hydroelectric generator illustrated in FIG. 9 wherein the building elements are removed to better show internal components.

FIG. 11 is a perspective cut-away view of a system for handling solid waste included in hydroelectric generators.

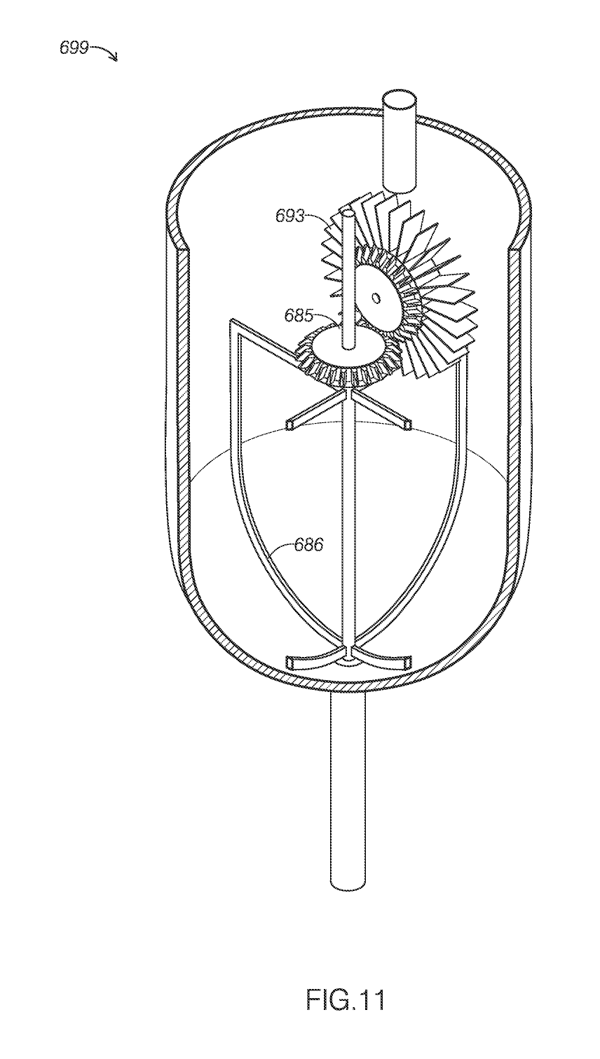

FIG. 12 is a perspective view of a seventh example of a hydroelectric generator wherein storm water and sewage disposal systems a building rotate turbines and generators on alternating floors within the building.

FIG. 13 is perspective view of an eighth example of a hydroelectric generator that collects and routes liquid from a spillway routed over the top of a dam including a hydroelectric generator using the liquid to rotate a turbine and generator.

FIG. 14 is a perspective view of a ninth example of a hydroelectric generator, the generator receiving fluid from a spillway pipe that bypasses a dam including a hydroelectric generator.

FIG. 15 is a perspective view of a tenth example of a hydroelectric generator, the hydroelectric generator routing fluid output from a generator within a hydroelectric dam to a collection of horizontally oriented turbines and generators.

FIG. 16 is a perspective view of an eleventh example of a hydroelectric generator, the hydroelectric generator routing fluid output from a generator within a hydroelectric dam to a collection of vertically oriented turbines and generators.

FIG. 17 is a perspective view of a twelfth example of a hydroelectric generator that includes a spillway pipe and a spillway release pipe attached to the spill way pipe.

FIG. 18 is a perspective view of a thirteenth example of a hydroelectric generator that includes a siphon pipe routed over the top of a hydroelectric dam.

FIG. 19 is a perspective view of a fourteenth example of a hydroelectric generator that includes a siphon with a first end below the input of a hydroelectric generator within the hydroelectric dam.

FIG. 20 is a perspective view of a fifteenth example of a hydroelectric generator that includes a siphon pipe routed over the top of a hydroelectric dam.

### DETAILED DESCRIPTION

The disclosed hydroelectric generators will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations, however, for the sake of brevity each and every contemplated variation is not individually described in the following detailed description.

Throughout the following detailed description, examples of various hydroelectric generators are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

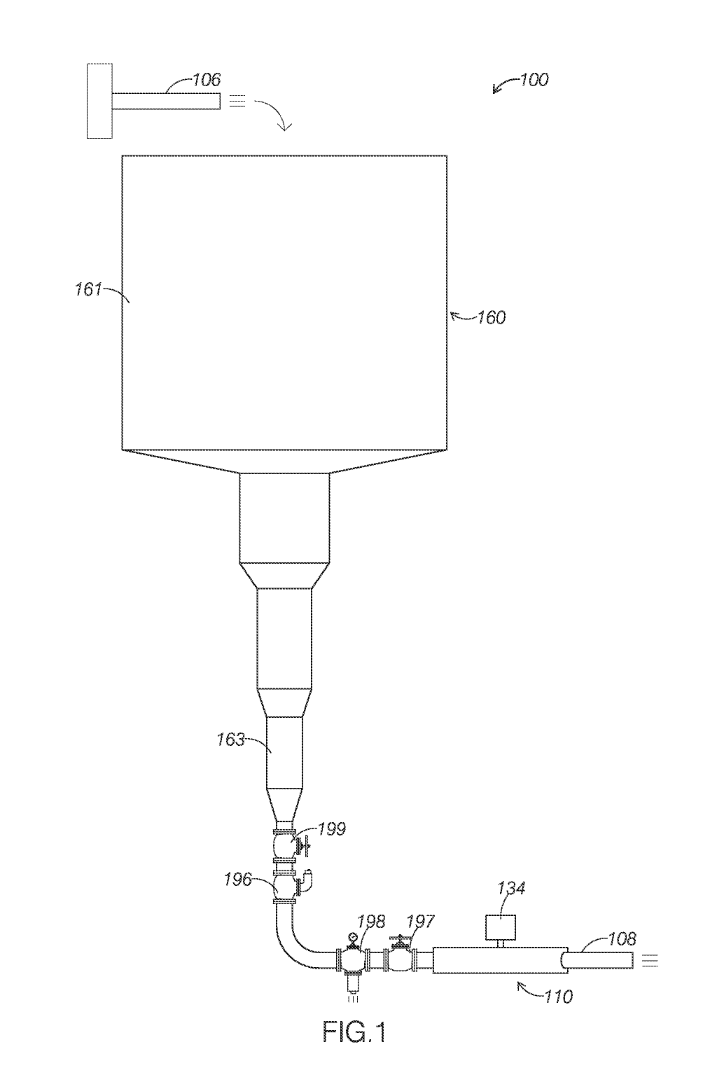

With reference to FIGS. 1-3 a hydroelectric generator 100 includes a liquid source 106, a collection body 160, a generation unit 110, and an output pipe 108. Hydroelectric generator 100 generally functions to collect a quantity of a liquid from liquid source 106 and build head pressure prior to allowing the liquid to flow through generation unit 110.

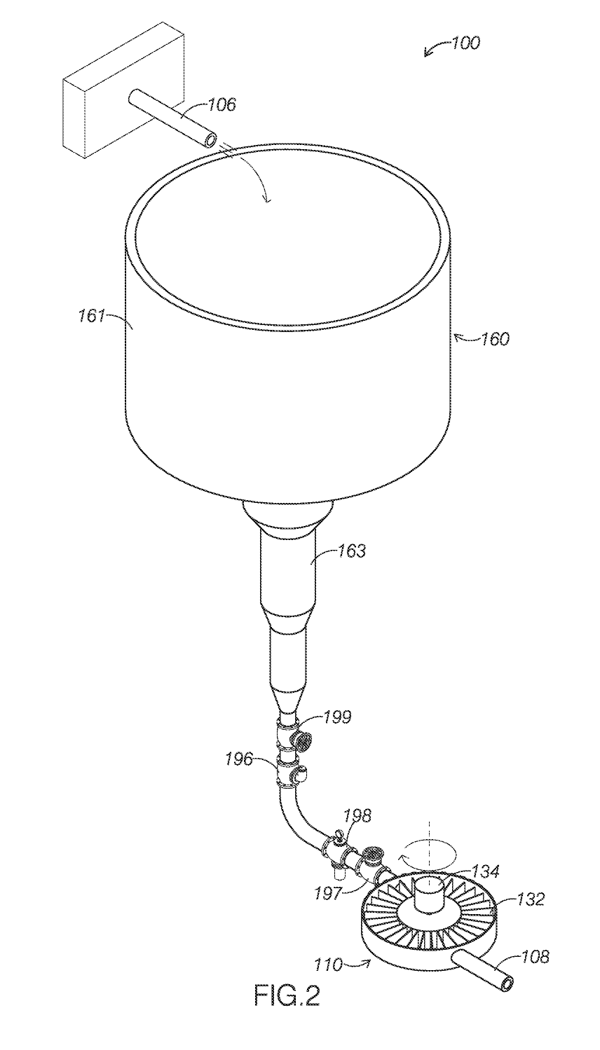

As FIGS. 1-3 show, liquid source 106 includes a pipe configured to direct liquid substantially into collection body 160. Liquid source 106 is illustrated in FIGS. 1-2 as a single pipe, however liquid source 106 may comprise many forms, including multiple pipes, vessels, bodies of liquid, and other fluid systems. For example, liquid source 106 may a conduit transporting pipe, natural fluid sources such as rainfall, streams, or rivers, or the output from other hydraulic and/or hydroelectric generation systems 3 illustrates hydroelectric generator 100 in such an alternative context wherein liquid source 106 includes the output of an external hydroelectric generation system 109.

Collection body 160 includes a storage tank 161, and a head pipe 163 connected to an opening substantially at the bottom of storage tank 161. Collection body 160 is configured to collect the liquid output from liquid source 106 and accumulate potential energy from the liquid contained within collection body 160 prior to communicating liquid to generation unit 110.

Storage tank 161 defines a container at a position below liquid source 106 configured to collect the liquid output from liquid source 106. Storage tank 161 defines an opening on its top end configured to collect liquid from liquid source 106 and an opening on its bottom end opening to head pipe 163.

Head pipe 163 defines a pipe that is connected to storage tank 161 on one end and generation unit 110 on the opposite end. Head pipe 163 configured to allow the liquid contained in storage tank 161 to pass to generation unit 110. The opening defined by the connection between head pipe 163 and generation unit 110 has a smaller area than the opening defined by the connection between head pipe 163 and storage tank 161. Head pipe 163 tapers from the width of storage tank 161 to the diameter of head pipe 163 along a portion of its length to define a funnel.

Head pipe 163 is configured to increase the flow rate of the fluid prior to communicating it to generation unit 110. Accumulating a reservoir of fluid feeding head pipe 163 under pressure and increasing the flow rate within head pipe 163 makes use of Bernoulli's Principal for more efficient for more efficient electricity generation downstream.

Accumulating potential energy within a contained liquid prior to sending the liquid to generation unit 110 encourages more efficient generation of electrical energy in hydroelectric contexts. Specifically, collecting liquid to generate a head prior to passing the liquid to the generation unit may allow liquid from low-flow sources to drive hydroelectric turbines and/or generators in contexts where flow alone would be otherwise insufficient. Additionally, some liquid received from liquid source 106 that would otherwise bypass hydroelectric generator 100 when operating at capacity may be stored within collection body 160 for future use.

Hydroelectric generator 100 additionally includes a valve 197 and gauge 198 positioned on head pipe 163 proximate generation unit 110.

Gauge 198 is configured to detect and display the current amount of pressure accumulated within head pipe 163. Gauge 198 is operationally connected with valve 197 to allow gauge 198 to communicate with valve 197.

Valve 197 is configured to open and release excess gas at liquid within head pipe 163 to substantially prevent damage to hydroelectric generator 100 resulting from an excess of liquid or gas pressure. Additionally, valve 197 is configured to open and close the connection between head pipe 163 and on unit 110. Valve 197 may be operated manually or automatically in concert with gauge 198, wherein valve 197 is configured to release a selected amount of gas and/or liquid from head pipe 163 upon gauge 198 detecting a selected amount of pressure within head pipe 163.

Hydroelectric generator 100 additionally includes a second valve 199 positioned upstream of valve 197. Second valve 199 provides additional control of the amount of liquid and pressure contained within hydroelectric generator 100.

Hydroelectric generator 100 includes an air release valve 196 proximate second valve 199, configured to release excess air within head pipe 163.

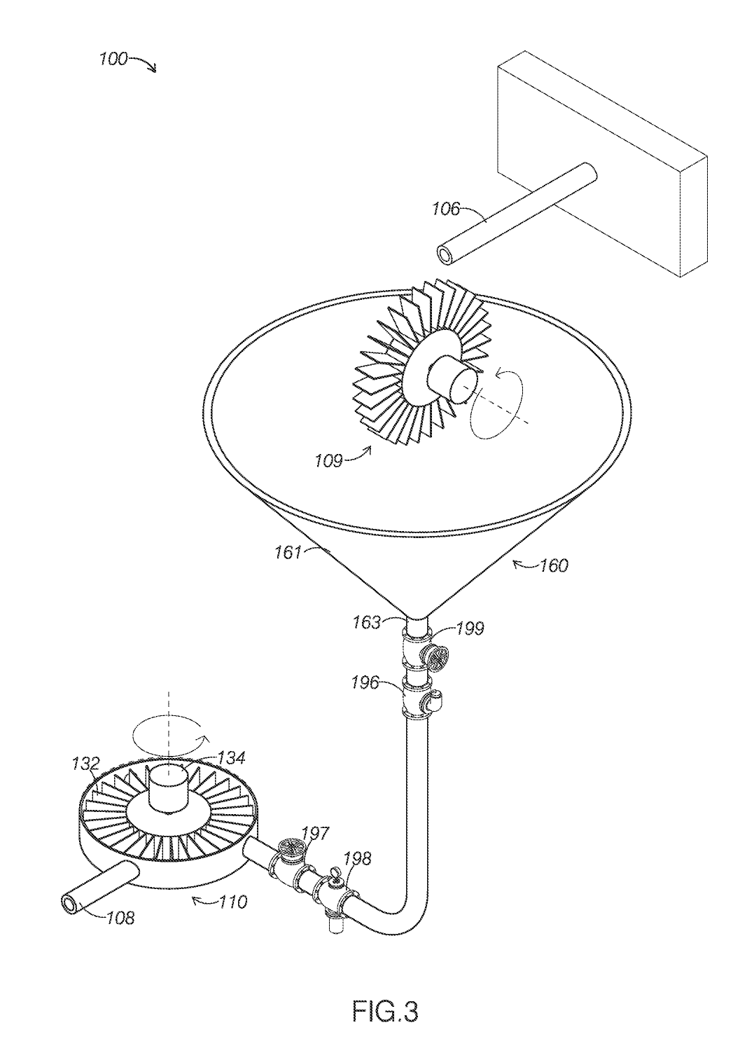

As FIGS. 2-3 illustrate, generation unit 110 defines an enclosed space that opens on one end to head pipe 163 and to output pipe 108 on the opposite end. Generation unit 110 includes a turbine 132 drivingly attached to a generator 134, both of which are located within the enclosed space. Generator 134 generates electrical energy as turbine 132 rotates. Generator 134 is additionally configured too connect to an external power system, allowing the distribution and/or storage of generated electrical energy.

Generation unit 110 is illustrated in FIG. 2-3 as having an open top. However, illustrating generation unit 110 in this manner is illustrative in purpose, specifically to show generation unit 110's internal components. In most contexts, generation units similar generation unit 110 are fully enclosed, as this allows more efficient generation of electrical energy.

Turbine 132 includes a collection of turbine blades that project radially around its perimeter and fill substantially all of the space within the enclosed space of generation unit 110. As liquid flows from head pipe 163 through generation unit 110, the liquid applies a torque to the turbine blades causing turbine 132 to rotate. As turbine 132 rotates, it drives generator 134, which converts the mechanical energy of turbine 132's rotation in to electrical energy.

Output pipe 108 is open on one end and connects to generator 134 on the opposite end. Output pipe 108 routes the liquid that has flowed through generation unit 110 to its opening on the opposite side. Though output pipe 108 is routed towards an undefined destination in FIGS. 1-3, output pipe 108 may be used to route the liquid output from hydroelectric generator 100 to a specific destination. For example, output pipe 108 may be used to output the liquid to a sewage line or waste utility. Output pipe 108 may additionally be used to route the output of hydroelectric generator 100 to a second hydroelectric generator. In this manner, output pipe 108 may define a liquid source for a second hydroelectric generator.

Hydroelectric generator 100 may be applied to many various contexts, particularly including those with a less than ideal liquid flow. However, this disclosure specifically contemplates implementing hydroelectric generator 100 in community liquid waste disposal systems, including storm water drainage systems and sewage systems in particular. In such contexts, hydroelectric generator 100 or multiple hydroelectric generators 100 may be placed in series at any point along the liquid waste disposal systems. Implementing hydroelectric generator 100 in this context harnesses a source of hydroelectric energy that is currently underutilized.

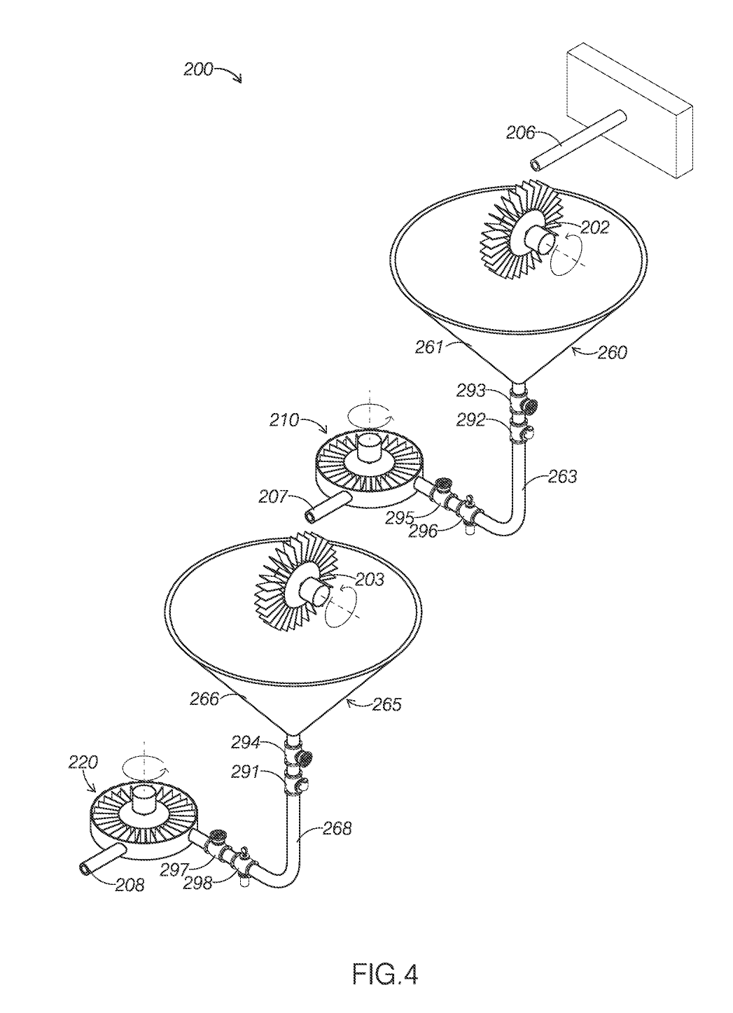

Turning attention to FIG. 4, a second example of a hydroelectric generator 200 now be described. Specifically, hydroelectric generator 200 serves an example of a hydroelectric generator in which the output serves as a liquid source of a second hydroelectric generator. Hydroelectric generator 200 includes many similar or identical features to hydroelectric generator 100 combined in unique and distinct ways. Thus, for the sake of brevity, each feature of hydroelectric generator 200 will not be redundantly explained. Rather, key distinctions between hydroelectric generator 100 and hydroelectric generator 200 will be described in detail and the reader should reference the discussion above for features substantially, similar between the two hydroelectric generators.

Hydroelectric generator 200 includes a first cascaded unit and a second cascaded unit downstream of the first cascaded unit, each of which is substantially similar to hydroelectric generator 100. Specifically, the first cascaded unit includes a liquid source 206, a first collection body 260, a first generation unit 210, and a first cascaded unit output 207. The second cascaded unit includes a second collection body 265, a second generation unit 220, and an output pipe 208.

First collection body 260 includes a first storage tank 261 and a first head pipe 263. These elements are configured to accumulate potential energy by containing a volume of liquid prior to sending the liquid to first generation unit 210, similar to the corresponding elements of hydroelectric generator 100.

Likewise, second collection body 265 includes a second storage tank 266 and a second head pipe 268. These elements are configured to accumulate potential energy by containing a volume of liquid prior to sending the liquid to second generation unit 220, similar to the corresponding elements of hydroelectric generator 100.

The first unit additionally includes a first valve 295 and first gauge 296, and the second cascaded unit includes a second valve 297 and second gauge 298. These elements are substantially similar to valve 19 and gauge 198; however, this disclosure additionally contemplates second gauge 298 being operationally connected to first calve 295. Connecting second gauge 298 to first valve 295 enables second gauge 298 to communicate pressure and liquid levels within the second cascaded unit and to allow first valve 295 to substantially control the flow rate of first cascaded unit output 207's.

Additionally, the first cascaded unit includes a first upstream valve 293 and a first upstream air release valve 292. The second cascaded unit includes a second upstream valve 294 and a second upstream air release valve 291. First upstream valve 293, second upstream valve 294, first upstream release valve 292, and second upstream air release valve 291 are each substantially similar to the corresponding elements of hydroelectric generator 100.

Hydroelectric generator 200 substantially defines two hydroelectric generators similar to hydroelectric generator 100 positioned in a cascaded arrangement. Specifically, first cascaded unit output 207 functions as both the output of the first cascaded unit and a liquid source of the second cascaded unit. Stated differently, the output of the first cascaded unit is collected in second storage tank 266, whereupon it is stored to generate a head pressure not to flowing through second generation unit 220.

Liquid source 206 is similar to liquid source 106, and may include any source of liquid previously mentioned in connection with liquid source 106. Additionally, though the second cascaded unit is configured specifically to collect water output from first cascaded unit output 207, it may collect liquid from other sources as well.

Routing the output of the first cascaded unit to serve as a liquid source of the second cascaded unit illustrates the concept of cascading multiple hydroelectric generators in series. Organizing hydroelectric generators in such a manner harnesses a liquid source at multiple stages, and leads to efficiency gains through using the same liquid source to generate electricity multiple times prior to discarding the liquid.

Although hydroelectric generator 200 includes two generators positioned in a cascaded organization, any number of hydroelectric generators positioned in a cascaded arrangement may be used. When multiple hydroelectric generators are employed, the output of each generator serves as an input for the subsequent generator, save the final output. The inventive subject matter of this disclosure, in relevant part, relates more to the cascaded organization of hydroelectric generators seen in hydroelectric generator 200 than the numerosity of the generators.

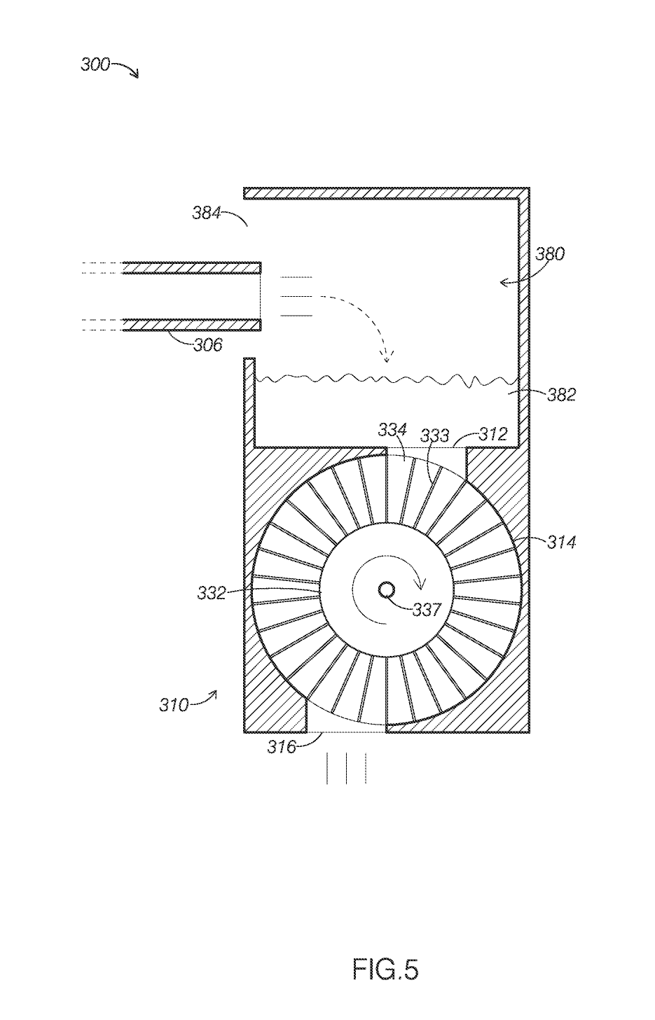

Turning attention to FIG. 5, a third example of a hydroelectric generator 300 will no be described. Hydroelectric generator 300 includes a liquid source 306, a liquid collector 380 and a generation unit 310.

Collection area 382 includes a collection area 382 and a pressure release 384. Collection area 382 defines a receptacle positioned substantially above generation unit 310 and is configured to collect and store liquid from liquid source 306. As liquid collects in collection area 382, pressure release 384 is configured to release pressure within a liquid collector 380, thereby assisting the maintenance of safe pressure levels within hydroelectric generator 300. Generation unit 310 includes a liquid input 312, a turbine space 314, and a liquid output 316. Hydroelectric generator 300 additionally includes a turbine 332 disposed within turbine space 314 which is drivingly connected to a generator 337.

Turbine 332 is disposed within turbine space 314 and includes a collection of turbine blades 333 that project radially from turbine 332 to fill substantially all of turbine space 314. Turbine blades 333 include a plurality of collecting bodies 334 defining containers positioned between each adjacent pair of turbine blades.

Hydroelectric generator 300 is configured to route liquid contained in collection area 382 to turbine space 314 via liquid id input 312. As the liquid enters turbine space 314, within collecting bodies 334. The accumulating liquid accumulates potential energy resulting from gravity acting on the increasing mass of liquid.

As the liquid contained in collecting bodies 334 increases in mass and potential energy, the liquid applies increasing amount of torque to turbine 332. Turbine 332 is configured to rotate as the torque applied by the liquid reaches a selected amount.

Turbine 332 is operationally connected to a generator 337 in a substantially similar manner to turbine 132 and generator 134. Generator 337 is also similarly configured to connect to an external power system.

Hydroelectric generator 300 may be particularly suited to contexts including less than ideal flow rates. Specifically, by accumulating liquid within collecting bodies 334, hydroelectric generator 300 may drive hydroelectric turbines and/or generators in contexts where the flow from liquid input 312's would be otherwise insufficient to drive the turbine or generator.

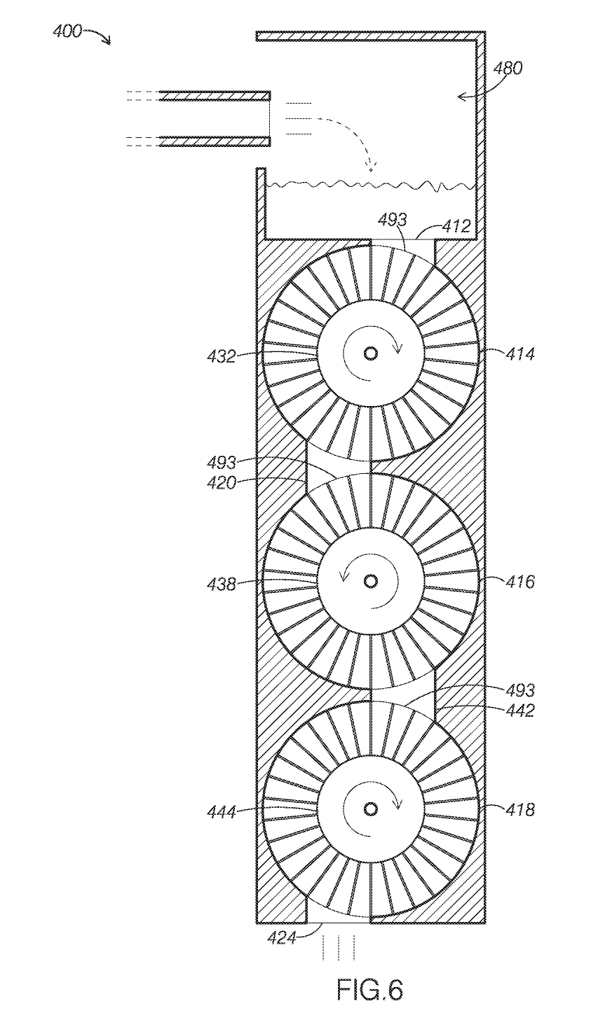

Turning attention to FIG. 6, a fourth example of a hydroelectric generator 400 will now be discussed. Hydroelectric generator 400 includes many similar or identical features to hydroelectric generator 300 combined in unique and distinct ways. Thus, for the sake of brevity, each feature of hydroelectric generator 400 will not be redundantly explained. Rather, key distinctions between hydroelectric generator 300 and hydroelectric generator 400 will be described in detail and the reader should reference the discussion above for features substantially similar between the two hydroelectric generators.

FIG. 6 shows that hydroelectric generator 400 is essentially a variation on hydroelectric generator 300 that includes three generators arranged in an alternating cascaded series. Specifically, hydroelectric generator 400 includes a generation unit 410 that defines a liquid input 412, a first turbine space 414, a second turbine space 416, a third turbine space 418, and a liquid output 424, each similar to the corresponding element of hydroelectric generator 300.

As shown in FIG. 6, generation unit 410 additionally defines a first channel 420 and a second channel 422. First channel 420 defines an opening between first turbine space 414 and second turbine space 416, and second channel 422 defines an opening between second turbine space 416 and third turbine space 418.

Hydroelectric generator 400 additionally includes a liquid collector 480 substantially similar to a liquid collector 380.

As can be seen in FIG. 6, hydroelectric generator 400 includes a first turbine 432, a second turbine 438, and a third turbine 444, each disposed at the corresponding turbine space and similar to turbine 332. Similar to turbine 332, each turbine defines a plurality of collection bodies 493 within the spaces between its blades, and is configured to drive a connected generator as collection bodies 493 collect liquid.

Generation unit 410 receives liquid from liquid input 412, routes the liquid through first turbine space 414, second turbine space 416, and third turbine space 418, and eventually sends the liquid out through liquid output 424. After the liquid has been used to drive first turbine 432 and second turbine 438, it flows through first channel 420 to second turbine space 416 and through second channel 422 to third turbine shave 418.

As liquid flows in to first turbine space 414, second turbine space 416, and third turbine space 418, the liquid fills collection bodies of first turbine second turbine 438, and third turbine 444, respectively, in a manner similar to hydroelectric generator 300. As discussed above, the liquid applies torque to the turbines as fills the collection bodies.

Liquid flows through generation unit 410 to each turbine alternating fashion illustrated in FIG. 6. Specifically, in the orientation depicted in 6, liquid flows in to the right side of first turbine space 414, the left side of second turbine space 416, and the right side of third turbine space 418.

Additionally, the turbines are configured to rotate in opposite directions. Specifically, as hydroelectric generator 400 is viewed in FIG. 6, first turbine 432 is configured to rotate clockwise, second turbine 438 is configured to rotate counter-clockwise, and third turbine 444 is configured to rotate clockwise.

Hydroelectric generator 400 additionally provides efficiency gains through its alternating turbine design. Arranging the turbines in an alternating fashion allows the liquid to apply a torque to the turbines over a greater portion of the turbine spaces and provides less resistance as the liquid cascades from one turbine to a subsequent turbine.

Similar to hydroelectric generator 300, hydroelectric generator 400 generates potential energy by accumulating liquid within the collection bodies, which applies increasing torque on the turbines. As a result, hydroelectric generator 400 is able to generate a greater amount of torque with a low flow input than would result without storing the liquid within the collection bodies. Accordingly, hydroelectric generator 400 may drive hydroelectric turbines and/or generators in contexts where the flow input would be otherwise insufficient.

Hydroelectric generator 400 additionally provides efficiency gains by cascading liquid from a single source through a plurality of generators, similar to hydroelectric generator 200. Specifically, hydroelectric generator 400 extracts a greater amount energy from the liquid and produces a greater amount of electricity than a single generator would prior to discarding the liquid.

Additionally, hydroelectric generator 400 is illustrated in FIG. 6 with precisely three turbines and generators. However, this is not specifically required, as the heart of the inventive subject matter lies more with including multiple cascaded turbines and generators arranged in an alternating manner. Accordingly, this disclosure specifically considers designs similar to hydroelectric generator 400 that include any number of plural cascading generators.

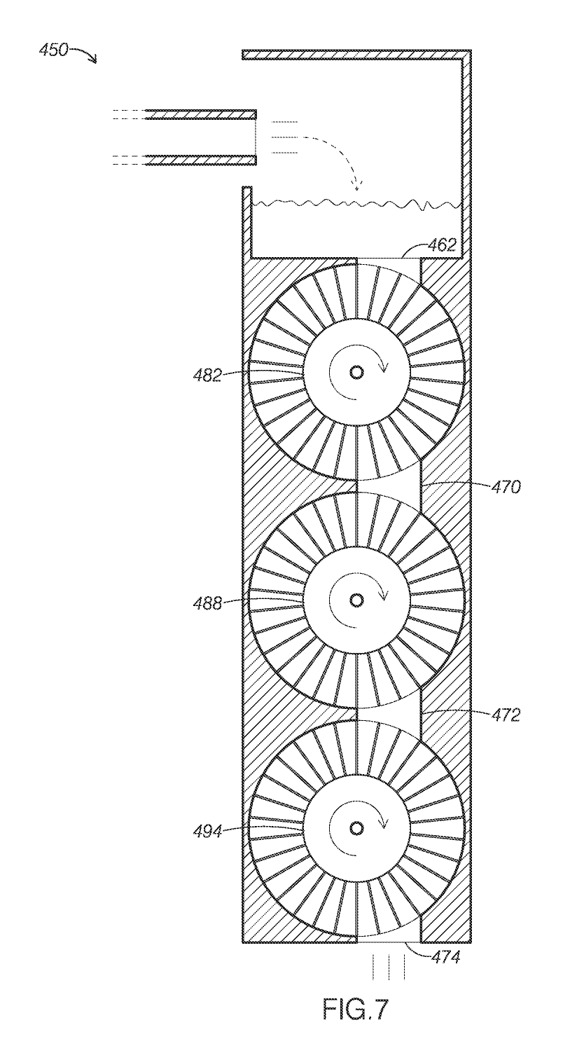

Turning attention to FIG. 7, a fifth example of a hydroelectric generator 450 will now be described. Hydroelectric generator 450 is substantially similar to hydroelectric generator 400, including a plurality of turbines organized vertically. Specifically, hydroelectric generator 450 includes a first turbine 482, a second turbine 488, and a third turbine 494. However, unlike hydroelectric generator 400's turbines, first turbine 482, second turbine 488, and third turbine 494 are configured to rotate in the same direction.

Additionally, hydroelectric generator 450 includes a liquid input 462, first channel 470, second channel 472, and liquid output 474, each of which is positioned substantially along the same side of a generation unit 460, rather than being positioned on alternate sides as one vertically traverses through the spaces between the turbines, as seen in hydroelectric generator 400.

Hydroelectric generator 450 primarily illustrates that, despite potential advantages of an alternating design, such a design is not specifically required.

Due to the similarity in their design, hydroelectric generator 300, hydroelectric generator 400, and hydroelectric generator 450 may substantially be used interchangeably. Additionally “storage turbine hydroelectric generator” shall hereinafter refer to a class of hydroelectric generators that includes hydroelectric generator 300, hydroelectric generator 400, hydroelectric generator 450, and variations similar to each.

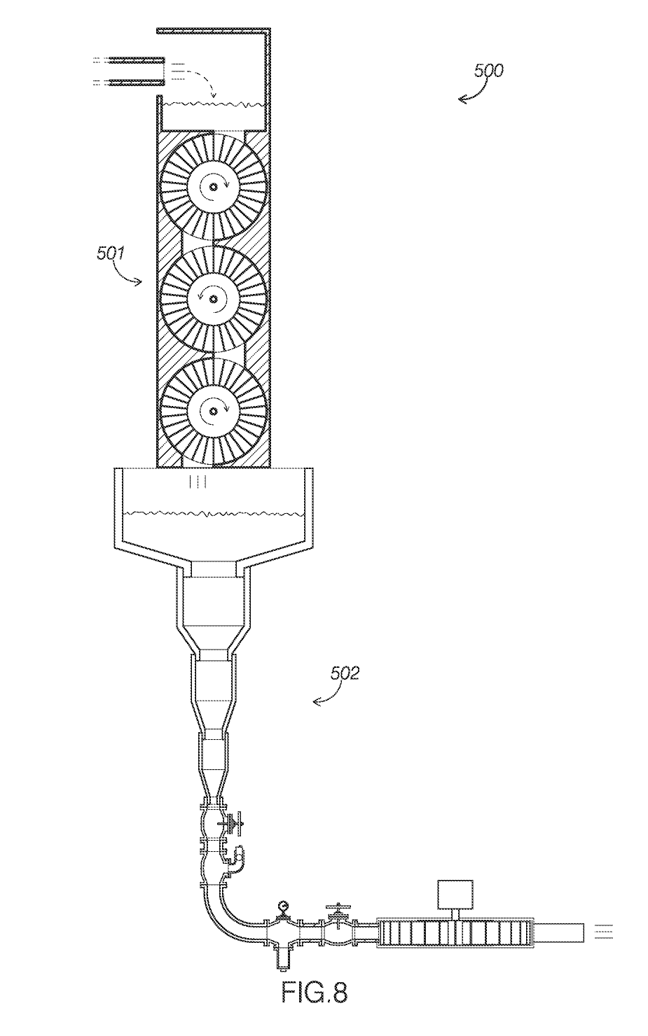

Turning attention to FIG. 8, a sixth example of a by hydroelectric generator 500 will now be described. Hydroelectric generator 500 includes any similar or identical features to hydroelectric generator 200 and hydroelectric generator 400 combined in unique and distinct ways. Thus, for the sake of brevity, each feature of hydroelectric generator 500 will not be redundantly explained. Rather, key distinctions between hydroelectric generator 200, hydroelectric generator 400, and hydroelectric generator 500 will be described in detail and the reader should reference the discussion above for features substantially similar between the three hydroelectric generators.

Hydroelectric generator 500 implements a storage turbine hydraulic generator, specifically hydroelectric generator 400, as one of its cascaded units. Specifically, hydroelectric generator 500 includes a first cascaded unit 501 and a second cascaded unit 502 that interact in a substantially similar manner to the cascaded units of hydroelectric generator 200, wherein the output of first cascaded unit 501 serves as the input of second cascaded unit 502. Second cascaded unit 502 is substantially similar to the second cascaded unit of hydroelectric generator 200.

A primary difference between hydroelectric generator 500 and hydroelectric generator 200 lies in implementing a storage turbine hydroelectric generator as first cascaded unit 501, wherein hydroelectric generator 200 included a hydroelectric generator substantially similar to hydroelectric generator 100. Hydroelectric generator 500 illustrates the interchangeability of various disclosed hydroelectric generators when used in cascaded arrangements. As previously mentioned, specific cascaded elements in cascaded designs similar to hydroelectric generator 200 or hydroelectric generator 500 may take any form of hydroelectricity generator, whether specifically disclosed or not.

FIG. 8 additionally illustrates first cascaded unit 501 above the top of second cascaded unit 502. This arrangement substantially prevents the liquid collected in second cascaded unit 502 from impeding the output of first cascaded unit 501, thereby reducing the risk of flooding first cascaded unit 501.

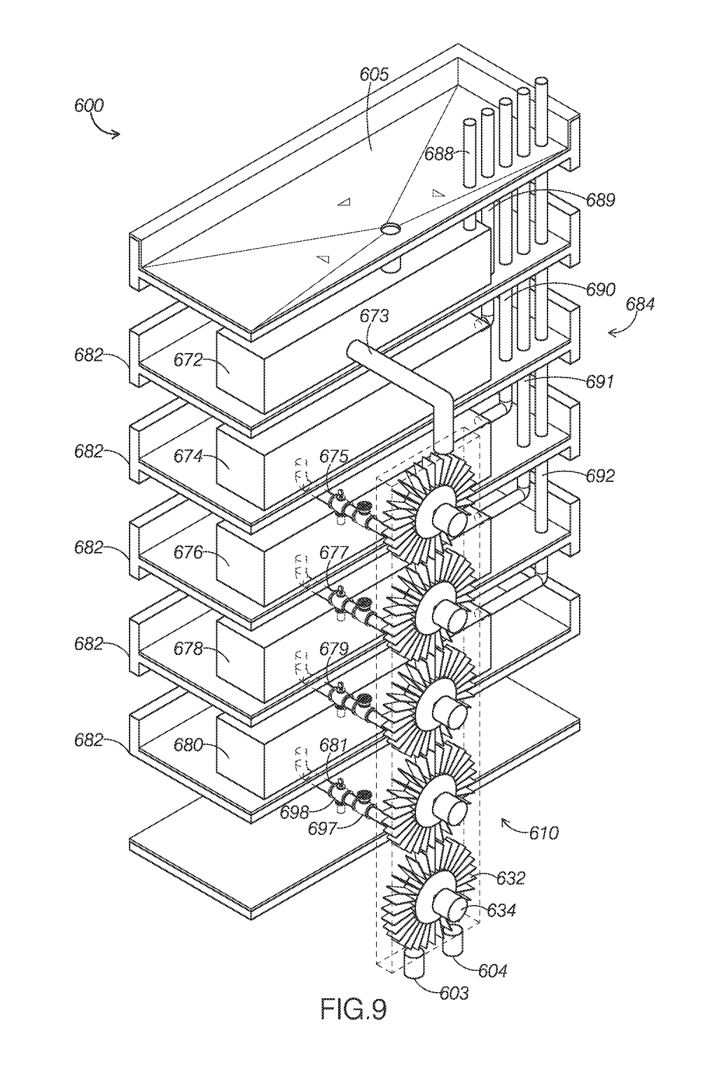

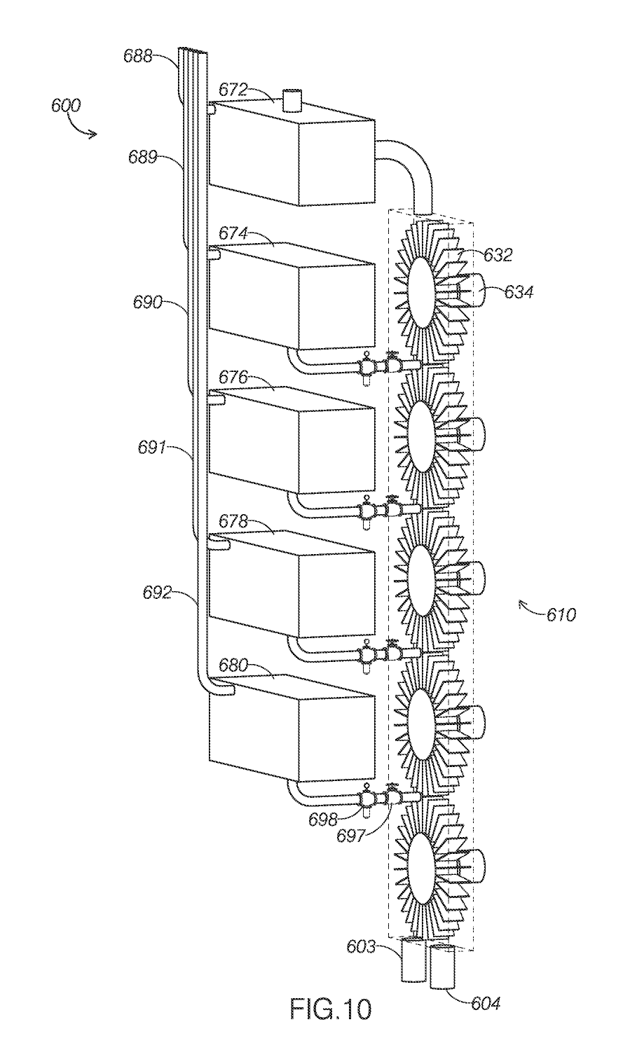

Turning attention to FIGS. 9 and 10, a seventh example of a hydroelectric generator 600 will now be described. Hydroelectric generator 600 shares many similar or identical features with previously disclosed examples of hydroelectric generators that are combined in unique and distinct ways. Thus, for the sake of brevity, each feature of hydroelectric generator 600 will not be redundantly explained. Rather, key distinctions between hydroelectric generator 600 and other previously disclosed example of hydroelectric generators will be described in detail and the reader should reference the discussion above for features substantially similar between the hydroelectric generators.

Hydroelectric generator 600 includes an environmental collection body 605, a generator system 610, and a collection of storage tanks: a first storage tank 672, a second storage tank 674, a third storage tank 676, a fourth storage tank 678, and a fifth storage tank 680. As illustrated in FIGS. 9 and 10, the storage tanks are vertically arranged, each located on a different floor 682 of a building 684.

Generator system 610 includes a vertically arranged collection of turbines 632, each turbine in the collection drivingly connected to a generator 634.

Generator system 610 additionally includes a first output 603 and a second output 604 positioned at the bottom of generator system 610. First output 603 and second output 604 are configured to route liquid from hydroelectric generator 600 to external waste disposal systems. First output 603 is configured to route the output of generator system 610, whereas second output 604 is configured to route liquid in a path that bypasses generator system 610, which may prevent hydroelectric generator 600 from flooding building 684. This specific dual output design is not specifically required, however. Single output designs and dual output designs wherein both outputs are connected to the generator system are equally within this disclosure.

Hydroelectric generator 600 additionally includes a collection of pipes, including: a first pipe 673, a second pipe 675, a third pipe 677, a fourth pipe 679, and a fifth pipe 681. Each pine fluidly connects a corresponding storage tank to generator system 610. Specifically, first pipe 673 connects first storage tank 672 to generator system 610, second pipe 675 connects second storage tank 674 to generator system 610, third pipe 677 connects a third storage tank 676 to generator system 610, fourth pipe 679 connects fourth storage tank 678 to generator system 610, and fifth pipe 681 connects fifth storage tank 680 to generator system 610.

The storage tanks each include a gauge 698 configured to detect and display data corresponding to conditions inside the corresponding storage tank. For example, gauge 698 may display the volume of liquid in the corresponding storage tank and any gas or liquid pressure within the corresponding storage tank.

The pipes each include a valve 697 configured to allow a user to manipulate the level of liquid flow between the connected storage tank and generator system 610. Each valve 697 is substantially similar to valve 197 and controls the flow of liquid between the connected storage tank and generator system 610. The valves'operation in this manner allows hydroelectric generator 600 to operate safely and/or efficiently when the storage tanks contain varying levels of liquid.

Hydroelectric generator 600 also includes a collection body pipe 671 fluidly connecting collection body pipe 671 with first storage tank 672.

First storage tank 672, second storage tank 674, a third storage tank 676, fourth storage tank 678, and fifth storage tank 680 are each configured to fill via building 684's liquid waste disposal systems, including septic, sewage, gray water and other means of disposing substantially liquid waste. Specifically, each storage tank is configured to collect the throughput of such systems from floors within building 684 at the same or higher elevation than the corresponding storage tank, harnessing gravity to maximize the efficiency of the storage of the liquid waste.

Additionally, environmental collection body 605 is configured to collect liquid from environmental sources, including storm water, and direct this collected liquid to first storage tank 672.

Hydroelectric generator 600 additionally includes a first vent 688, a second vent 689, a third vent 690, a fourth vent 691, and a fifth vent 692. Each vent is connected on a first end to its corresponding storage tank, and includes an opposite end routed out of the top of building 684 on the opposite end. The vents are configured to release pressure from the storage tanks, substantially reducing the risk of implosion to the corresponding storage tank or to hydroelectric generator 600 overall.

FIG. 10 illustrates a detailed view of a solid waste mixer 699 included within second storage tank 674, a third storage tank 676, fourth storage tank 678, and fifth storage tank 680. Each solid waste mixer 699 includes a storage tank turbine 693, a storage tank gear 685, and metal bodies 686 positioned within the interior of each tank.

As liquid enters solid waste mixer 699, the liquid cascades over storage tank turbine 693, which is drivingly connected to storage tank gear 685. Metal bodies 686 are drivingly connected to storage tank gear 685 and substantially extend within the volume of the storage tank. As liquid cascades over storage tank turbine 693, metal bodies 686 are configured to rotate around the interior of the storage tank and substantially reduce the size of bodies of solid waste contained therein.

This disclosure specifically contemplates embodiments in which multiple storage tank mixers are positioned within one or more storage tanks. As a specific example, the storage tank may include a collection of mixers whose areas of operation overlap, similar to the operation seen in a dual-element electronic hand mixer.

Hydroelectric generator 600 is configured to accumulate liquid in the storage tanks, collected from the various disclosed sources, and thereby accumulate potential energy in the liquid body contained within the storage tanks. Upon collecting a selected amount of liquid and potential energy, hydroelectric generator 600 is configured to communicate the contents of the liquid body to generator system 610. As the liquid cascades through generator system 610, the liquid applies torque to turbines 632 that are drivingly connected to generators 634. Generators 634 are electrically connected to external electrical distribution networks, which may include the electrical network distributing power to building 684.

Hydroelectric generator 600 provides efficiency gains through harnessing a liquid source that is otherwise underutilized. Additionally, it provides efficiency gains through by including a mechanism powered by the liquid source itself to break up solid waste contained within the liquid source. Hydroelectric generator 600 also provides efficiency gains by storing liquid waste within the storage tanks to accumulate potential energy when the flow would otherwise be insufficient to power a hydroelectric generator.

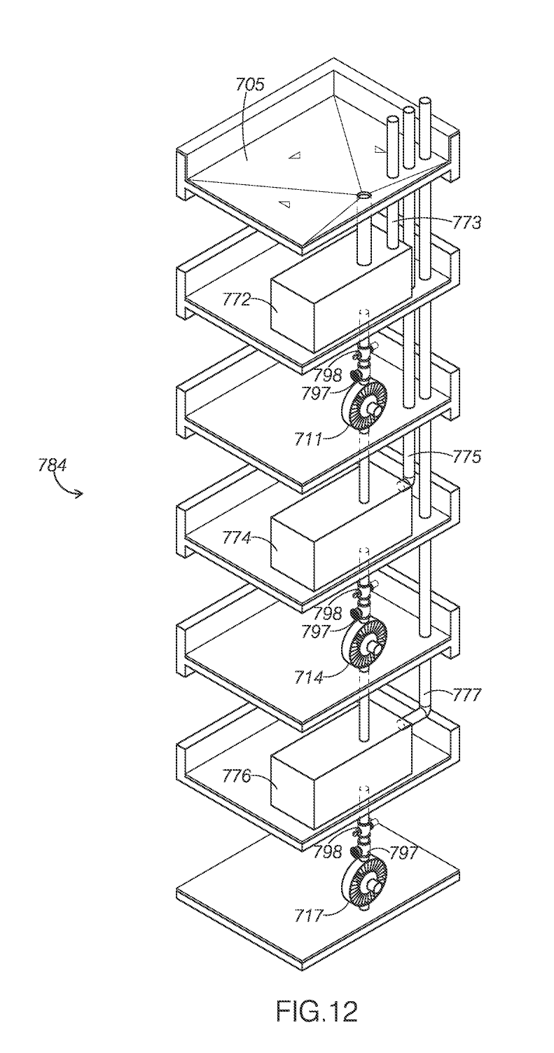

Turning attention to FIG. 12, an eighth example of a hydroelectric generator, hydroelectric generator 700, will now be described. Hydroelectric generator 700 shares many similar or identical features with hydroelectric generator 600 that are combined in unique and distinct ways. Thus, for the sake of brevity, each feature of hydroelectric generator 700 will not be redundantly explained. Rather, key distinctions between hydroelectric generator 700 and other previously disclosed examples of hydroelectric generators will be described in detail and the reader should reference the discussion above for features substantially similar between the hydroelectric generators.

As FIG. 12 illustrates, hydroelectric generator 700 includes a first storage tank 772, a second storage tank and a third storage tank 776 positioned on alternating floors of a building 784. The storage tanks are configured to accumulate liquid from the liquid waste disposal systems of building 784 similar the storage tanks of hydroelectric generator 600. Hydroelectric generator 700 additionally includes an environmental collection body 705 similar to environmental collection body 605 and is similarly connected to first storage tank 672.

Additionally, the storage tanks are substantially similar to the storage tanks of hydroelectric generator 600. Specifically, each storage tank includes internal components similar to storage tank gear 685 and metal bodies 686 illustrated in FIG. 10.

The storage tanks are attached to vents to release pressure within the elements of hydroelectric generator 700 and to prevent implosion of the storage tanks and other connected elements. Specifically, first storage tank 772 is connected to first vent 773, second storage tank 774 is connected to second vent 775, and third storage tank 776 is connected to third vent 777, each vent being connected to the storage tank at one end and routed through the roof of building 784 on the opposite end.

Unlike, the design of hydroelectric generator 600, in which each of the storage tanks is in fluid communication with a single generator system 610, each storage tank included in hydroelectric generator 700 is in fluid communication with a generation unit positioned on the adjacent floor of building 784 below the corresponding storage tank. Specifically, first storage tank 772 is in fluid communication with first generation unit 711, second storage tank 774 is in fluid communication with second generation unit 714, and third storage tank 776 is in fluid communication with third generation unit 717.

Additionally, the generation units are configured to output liquid to the storage tank on the floor of building 784 below the corresponding generation unit. Specifically, first generation unit 711 outputs to second storage tank 774 and second generation unit 714 outputs to third storage tank 776. Third generation unit configured to output liquid to an external liquid waste disposal means, specifically including sewage lines or storm water drainage systems.

Additionally, the pipes connecting each storage tank to the adjacently downstream generator includes a valve 797 and gauge 798, similar in operation to the valves and gauges described in relation to hydroelectric generator 600. Similar to the valves and gauges in hydroelectric generator 600, these valves and gauges are configured to allow greater control of pressure and/or the amount of stored liquid and may be configured for manual or automatic operation.

Though not illustrated, hydroelectric generators similarly designed to hydroelectric generator 700 may be configured with a pipe or collection of pipes that route the liquid contained in the storage tanks directly into wastewater disposal means. This allows hydroelectric generator 700 to safely dispose of excess liquid within the storage tanks in high flow contexts.

As liquid accumulates in each storage tank, hydroelectric generator 700 accumulates potential energy, similar to hydroelectric generator 600. Upon teaching a selected amount of potential energy, a storage tank communicates the liquid to the connected generation unit on the floor adjacently below the storage tank. The generation units of hydroelectric generator 700 are substantially similar to generation unit 110, and are likewise connected to an external electrical distribution system for usage and/or storage. This disclosure specifically contemplates using this energy within building 784 and/or distributing the generated energy to power systems substantially external to building 784.

FIG. 12 illustrates one potential design hydroelectric generator 700 where the connections between storage tanks and generation units are relatively short segments of pipe. In many designs, the length of these connections may be considerably longer relative the other units, and may in some cases extend several hundred feet. This disclosure specifically contemplates designs including connections between storage tanks and generation units that extend any length.

Although hydroelectric generator 700 illustrated in FIG. 12 includes generators similar to generation unit 110, this is not specifically required. Hydroelectric generators similar to hydroelectric generator 700 include any disclosed type of generator unit or system, specifically including storage turbine hydroelectric generators.

Both hydroelectric generator 600 and hydroelectric generator 700 are generally illustrative of hydroelectric generators situated within a building. Although these particular examples are illustrated with a specific number of floors, this disclosure specifically contemplates the general concepts embodied by these designs to be applied to buildings of any number of floors. Specifically, this disclosure contemplates any design accumulating a potential energy in a liquid body by storing various forms of substantially liquid waste from a building into a storage tank or a plurality of storage tanks located within the building and outputting this liquid containing the potential energy to a hydroelectric generator or a plurality thereof.

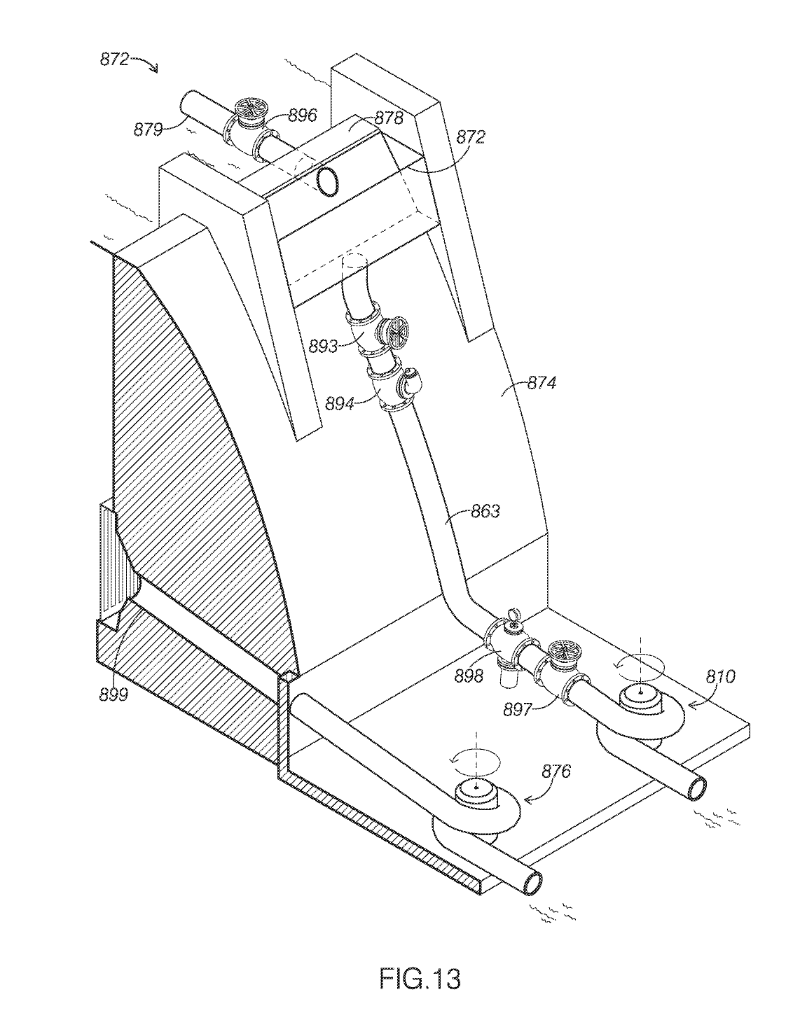

Turning attention to FIG. 13, an ninth example of a hydroelectric generator, hydroelectric generator 800, will now be described. Hydroelectric generator 800 shares many similar or identical features with previously disclosed examples of hydroelectric generators that are combined in unique and distinct ways. Thus, for the sake of brevity, each feature of hydroelectric generator 800 will not be redundantly explained. Rather, key distinctions between hydroelectric generator 800 and other previously disclosed examples of hydroelectric generators will be described in detail and the reader should reference the discussion above for features substantially similar between the hydroelectric generators.

Turning attention to FIG. 13, an ninth example of a hydroelectric generator, hydroelectric generator 800, will now be described. Hydroelectric generator 800 shares many similar or identical features with previously disclosed examples of hydroelectric generators that are combined in unique and distinct ways. Thus, for the sake of brevity, each feature of hydroelectric generator 800 will not be redundantly explained. Rather, key, distinctions between hydroelectric generator 800 and other previously disclosed examples of hydroelectric generators will be described in detail and the reader should reference the discussion above for features substantially similar between the hydroelectric generators.

FIG. 13 illustrates hydroelectric generator 800 connected to a dam 874 impeding a liquid source 872. As FIG. 13 illustrates, hydroelectric generator 800 includes a top spillway 878, a spillway pipe 879, a spillway collecting body 872, a generation unit 810, and a pipe 863.

Dam 874 additionally includes a dam hydroelectric generator 876 that uses the potential energy contained in liquid source 872 flowing through a penstock 899. Dam hydroelectric generator hydroelectric 876 is configured to generate electrical energy independent of hydroelectric generator 800.

Hydroelectric generator 800 includes a top spillway 878 routed over a selected segment of the top of dam 874. Top spillway 878 is configured to direct a portion of liquid source 872 when the surface level of liquid source 872 rises above the top of dam 874. Hydroelectric generator 800 additionally includes a spillway pine 879 connected directly to liquid source 872 on a first end and to spillway collecting body 872 on the opposite end. Spillway pipe 879 includes a spillway valve 896 proximate liquid source 872.

Top spillway 878 and spillway pipe 879 are collectively configured to direct a portion of liquid source 872 over and/or around dam 874 if it contains a selected amount of excess liquid. Top spillway 878 and spillway pipe 879 are additionally configured to route a certain amount of the excess liquid to spillway collecting body 872. Spillway pipe 879 is specifically configured to selectively communicate liquid from liquid source 872 through opening and closing spillway valve 896.

Hydroelectric generator 800 is configured at to hydroelectric generator 100, wherein spillway collecting body 872 is configured to collect liquid flowing over top spillway 878 and through spillway pipe 879 in a similar manner to how collection body 160 is configured to collect a liquid from liquid source 106. As liquid is collected in spillway collecting body 872, it is funneled and directed to generation unit 810 via pipe 863.

Pipe 863 includes a valve 897 and gauge 898 positioned proximate generation unit 810. Gauge 898 similar to gauge 198, is configured to detect and display the current amount of pressure accumulated within pipe 863. Valve 897 is configured to release excess pressure from pipe 863 by opening to release excess gas or liquid contained herein, which may substantially prevent damage to hydroelectric generator 800 resulting from an excess of liquid or gas pressure. Additionally, valve 897 substantially ensures that liquid flows through generation unit 810 at a selected rate of flow. Valve 897 and gauge 898, similar to valve 197 and gauge 198, may be configured for either manual or automatic operation.

Hydroelectric generator 800 additionally includes an upstream valve 893 and an upstream air release valve 894. Upstream valve 893 is substantially similar to second valve 199, and upstream air release valve 894 is substantially similar to air release valve 196.

Prior to communicating the liquid contained within spillway collecting body 872 and pipe 863 to generation unit 810, hydroelectric generator 800 accumulates potential energy similar to hydroelectric generator 100. Specifically, hydroelectric generator 800 accumulates potential energy by establishing a head of liquid prior to communicating the liquid to generation unit 810.

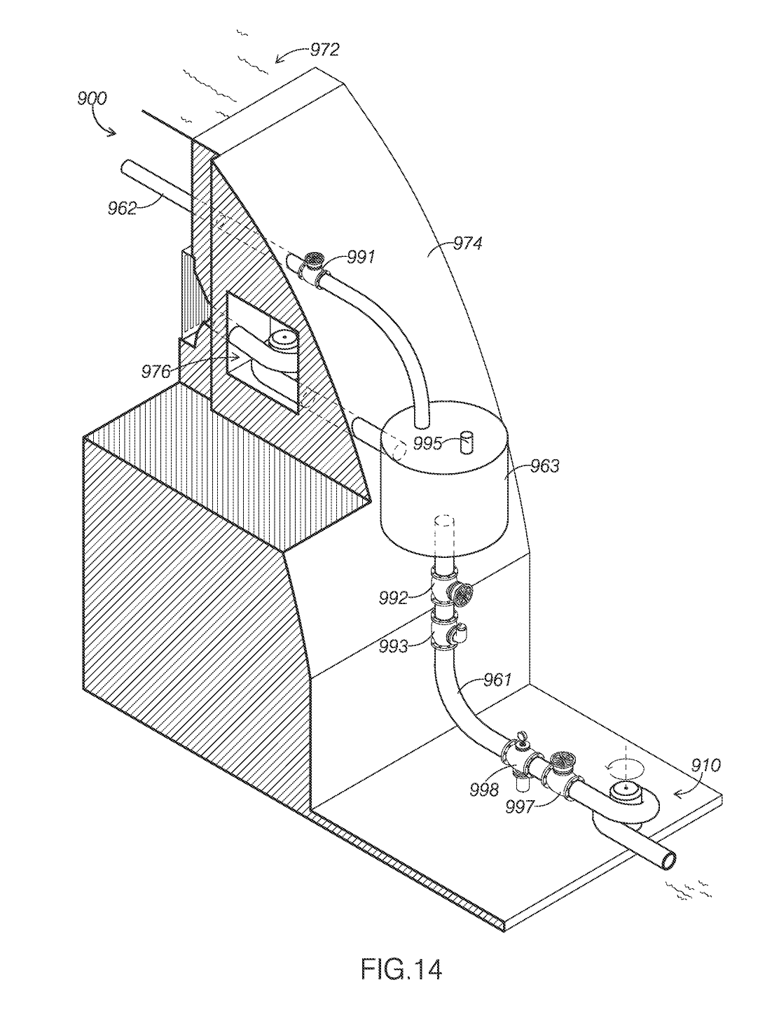

Turning attention to FIG. 14, a tenth example of a hydroelectric generator, hydroelectric generator 900, will now be described. Hydroelectric generator 900 shares many similar or identical features with previously disclosed examples of hydroelectric generators that are combined in unique and distinct ways. Thus, for the sake of brevity, each feature of hydroelectric generator 900 will not be redundantly explained. Rather, key distinctions between hydroelectric generator 900 and other previously disclosed examples of hydroelectric generators will be described in detail and the reader should reference the discussion above for features substantially similar between the hydroelectric generators.

As FIG. 14 illustrates, hydroelectric generator 900 is connected to a dam 974 impeding a liquid source 972 that produces a current. The dam includes a dam interior hydroelectric generator 976 that uses the al energy contained in liquid source 972 to generate electrical energy.

Hydroelectric generator 900 includes a spillway channel 962 substantially routed through dam 974. Hydroelectric generator 900 includes a collection body 963 connected to and configured to collect the output of spillway channel 962 and the output of dam interior hydroelectric generator 976. Hydroelectric generator 900 additionally includes a head pipe 961 connected to collection body 963 on a first end and to a generation unit 910 on the opposite end.

Similar to hydroelectric generator 800, hydroelectric generator 900 includes a spillway valve 991 that selectively communicates liquid from liquid source 972 through spillway channel 962.

As FIG. 14 shows, hydroelectric generator 900 is substantially similar to hydroelectric generator 800. A primary difference between hydroelectric generator 900 and hydroelectric generator 800 lies in how it collects the output of dam interior hydroelectric generator 976 and sends it to generation unit 910 in addition to spillway channel 962. After liquid is collected within collection body 963, the collected liquid is distributed to generation unit 910 in a manner substantially similar to hydroelectric generator 800. Additionally, generation unit 910 functions substantially similar to generation unit 810.

Hydroelectric generator 900 additionally includes a valve 997 and a gauge 998 positioned at a position on head pipe 961 upstream of generation unit 910. Valve 997 and gauge 998 regulate the liquid flow and pressure within head pipe 961 and generation unit 910 in a manner substantially similar to valve 197 and gauge 198.

Head pipe 961 additionally includes a head pipe valve 992, an air release valve 993, and a pressure release opening 995. Head pipe valve 992 is configured to open and close, allowing the selective distribution of liquid through head pipe. 961. Release pipe 964 is configured to release any excess pressure contained within collection body 963 is it collects liquid. Air release valve 993 is substantially similar to air release valve 196.

As the surface of liquid source 972 rises to a selected level, excess liquid is routed through spillway channel 962. As the liquid passes through spillway channel 962, it accumulates potential energy within head pine 961, substantially similar to hydroelectric generator 800 and/or hydroelectric generator 100. Upon generating a sufficient amount of potential energy, the liquid is then routed through a generation unit 910, which operates substantially similar to generation unit 110.

Additionally, hydroelectric generator 900 includes a mechanism similar to the one illustrated in FIG. 10 for breaking up solid materials within head pipe 961. The mechanism in hydroelectric generator 900 is substantially similar to storage tank gear 685 and metal bodies 686 described above. Including such a mechanism for breaking up solid waste within head pipe 961 illustrates that the mechanism is not limited to hydroelectric generator 600 and hydroelectric generator 900, and it may included in a similar manner within other hydraulic generators.

In particular, implementing systems such as that seen in FIG. 10 may be particularly useful for breaking up solid waste in hydroelectric generators including storage tank similar to storage tank 161, particularly in sewage disposal systems. Additionally, such systems may be implemented in systems including dams similar to dam 974, particularly in systems in which the liquid is routed from a spillway to similarly break up bodies that may be contained within a natural liquid source such as a river.

Hydroelectric generator 800 and hydroelectric generator 900 are designed to augment electrical energy generation hydroelectric dam contexts by harnessing potential energy within a spillway that would otherwise be wasted. As a result, this disclosure contemplates using hydroelectric generators downstream hydroelectric dam spillway to harness this energy, specifically including, but not limited, to those presently disclosed.

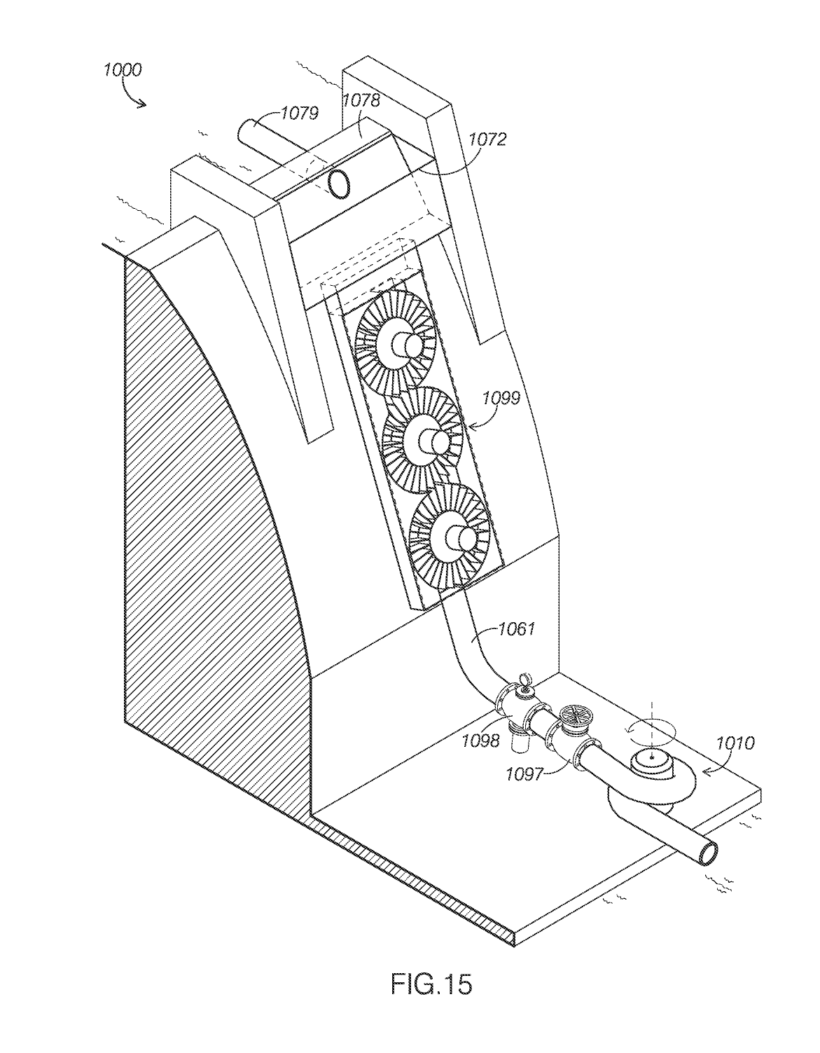

Turning attention to FIG. 15, an eleventh example of a hydroelectric generator, hydroelectric generator 1000, will now be described. Hydroelectric generator 1000 shares many similar or identical features with previously disclosed examples of hydroelectric generators that are combined in unique and distinct ways. Thus, for the sake of brevity, each feature of hydroelectric generator 1000 will not be redundantly explained. Rather, key distinctions between hydroelectric generator 1000 and other previously disclosed examples of hydroelectric generators will be described in detail and the reader should reference the discussion above for features substantially similar between the hydroelectric generators.

As FIG. 15 illustrates, hydroelectric generator 1000 includes a dam 1074 impeding a liquid source 1072. Hydroelectric generator 1000 includes a spillway pipe 1079, a top spillway 1078, and a spillway collection body 1072, each substantially similar in design and function to the corresponding elements of hydroelectric generator 800.

Hydroelectric generator 1000 includes a storage turbine hydroelectric generator 1099 in fluid communication with spillway collection body 1072. Hydroelectric generator 1000 additionally includes a head pipe 1061 connected to the output of storage turbine hydroelectric generator 1099 on a first end and to a generation unit 1010 on the opposite end.

Hydroelectric generator 1000 includes a valve 1097 and a gauge 1098 positioned on head pipe 1061 upstream of generation unit 1010. Valve 1097 and gauge 1098 operate to regulate the liquid flow and pressure within head pipe 1061 and generation unit 1010 in a manner substantially similar to valve 197 and gauge 198.

Hydroelectric generator 1000 is configured to operate substantially similar to hydroelectric generator 800. However, hydroelectric generator 1000 further harnesses the potential energy contained with the liquid by powering the generators contained within storage turbine hydroelectric generator 1099 prior to communicating the liquid stored in spillway collection body 1072 to head pipe 1061.

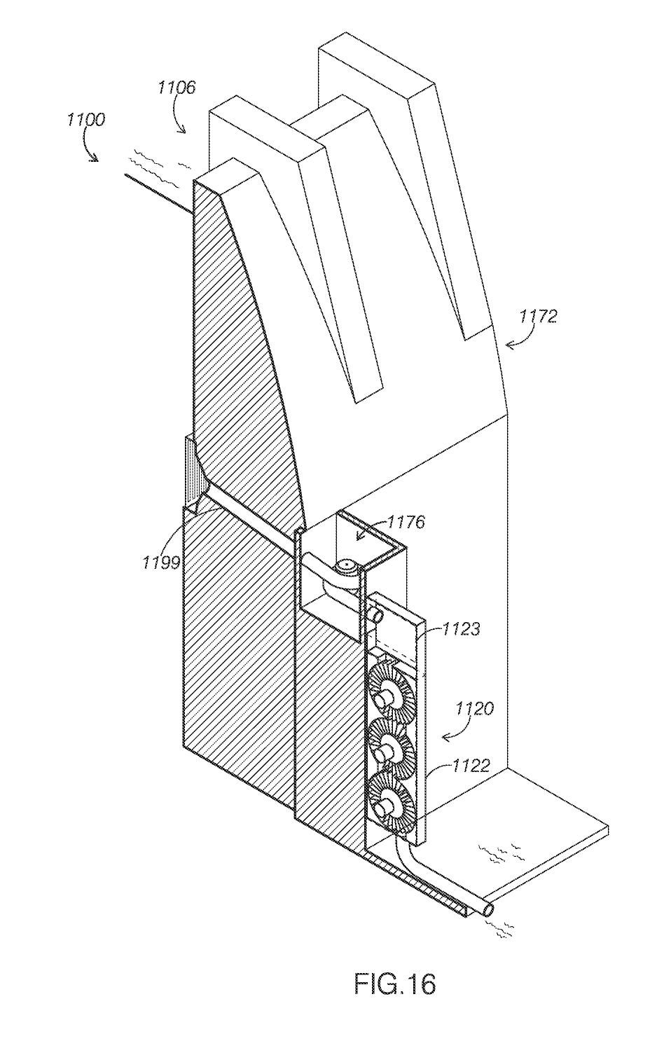

Turning attention to FIG. 16, a twelfth example of a hydroelectric generator, hydroelectric generator 1100, will now be discussed. Hydroelectric generator 1100 shares many similar or identical features with previously disclosed examples of hydroelectric generators that are combined in unique and distinct ways. Thus, for the sake of brevity, each feature of hydroelectric generator 1100 will not be redundantly explained. Rather, key distinctions between hydroelectric generator 1100 and other previously disclosed examples of hydroelectric generators will be described in detail and the reader should reference the discussion above for features substantially similar between the hydroelectric generators.

Hydroelectric generator 1100 includes a dam 1172 and a downstream aeration system 1120. Hydroelectric generator 1100 is generally configured to route the output of a hydroelectric generator within a dam to a storage turbine hydroelectric generator.

Dam 1172 includes a penstock 1199 and dam generator 1176. Dam 1172 is configured to impede a liquid source 1106 and to substantially accumulate a potential energy within liquid source 1106.

Penstock 1199 is configured to communicate liquid from liquid source 1106 to dam generator 1176. Dam generator 1176 is configured to generate electricity through via the communicated liquid, substantially similar to generation unit 110.

Downstream generation system 1120 is configured to collect the output of dam generator 1176 and to route it through a storage turbine hydroelectric generator 1122. This arrangement allows greater efficiency over a typical hydroelectric dam design by using the output of dam generator 1176 to power a downstream generator. Additionally, implementing storage turbine hydroelectric generator 1122, which includes collection area 1123 allows liquid to be collected for downstream generation without impeding the flow of liquid through dam generator 1176.

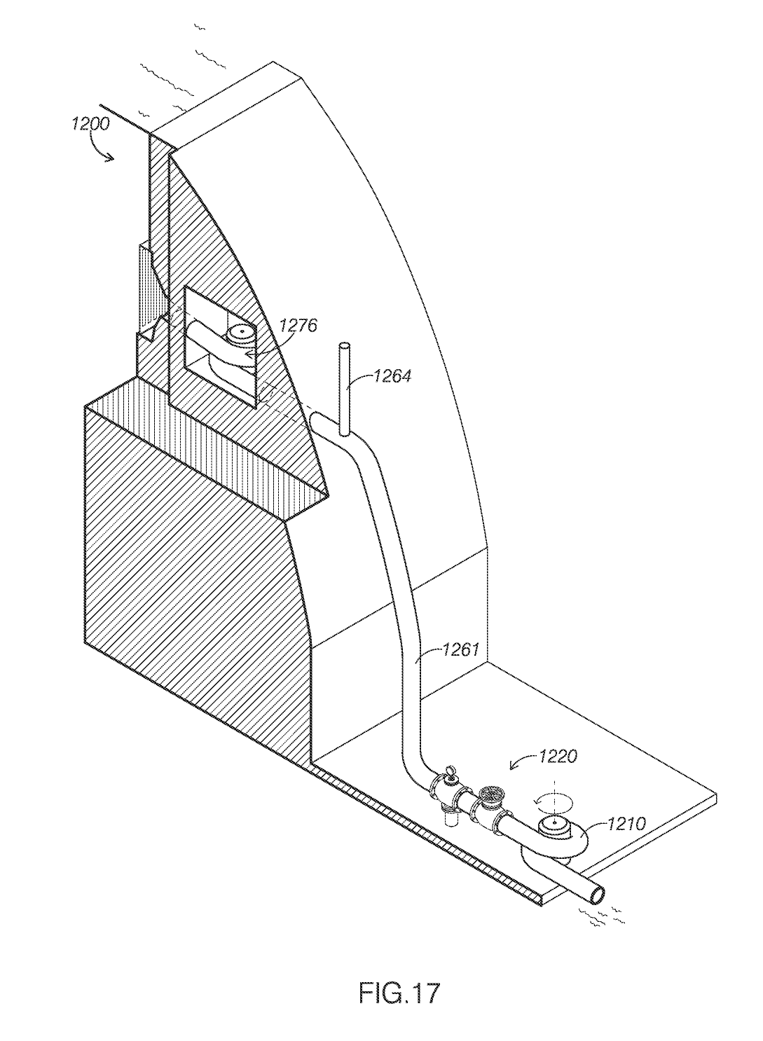

Turning attention to FIG. 17, a thirteenth example of a hydroelectric generator, hydroelectric generator 1200, will now be discussed. Hydroelectric generator 1200 shares many similar or identical features with previously disclosed examples of hydroelectric generators that are combined in unique and distinct ways. Thus, for the sake of brevity, each feature of hydroelectric generator 1200 not be redundantly explained. Rather, key distinctions between hydroelectric generator 1200 and other previously disclosed examples of hydroelectric generators will be described in detail and the reader should reference the discussion above for features substantially similar between the hydroelectric generators.

Hydroelectric generator 1200 is substantially similar to hydroelectric generator 1100, as it implements a dam generator 1276 in fluid communication with a downstream generation system 1220. However, unlike downstream generation system 1120, downstream generation system 1220 is not a storage turbine hydroelectric generator. Instead, downstream generation system 1220 includes a head pipe 1261 and a generation unit 1210 that operate substantially similar to head pipe 163 and generation unit 110.

Hydroelectric generator 1200 additionally includes a release pipe 1264 due to the potential for pressure to accumulate within head pipe 1261 without adequate means for release due to dam generator 1276 being positioned upstream. Release pipe 1264 is configured to release such accumulated pressure in a substantially safe manner.

Though release pipe 1264 is discussed specifically in connection with hydroelectric generator 1200, the use of release pipes in general is not limited to hydroelectric generators similar to hydroelectric generator 1200. Release pipes may be implemented in any of the disclosed hydroelectric generators. Release pipes that are connected and controlled by valves and/or gauges are both within this disclosure. As a specific example, hydroelectric generator 900 includes a release pipe 964 positioned on collection body 963.

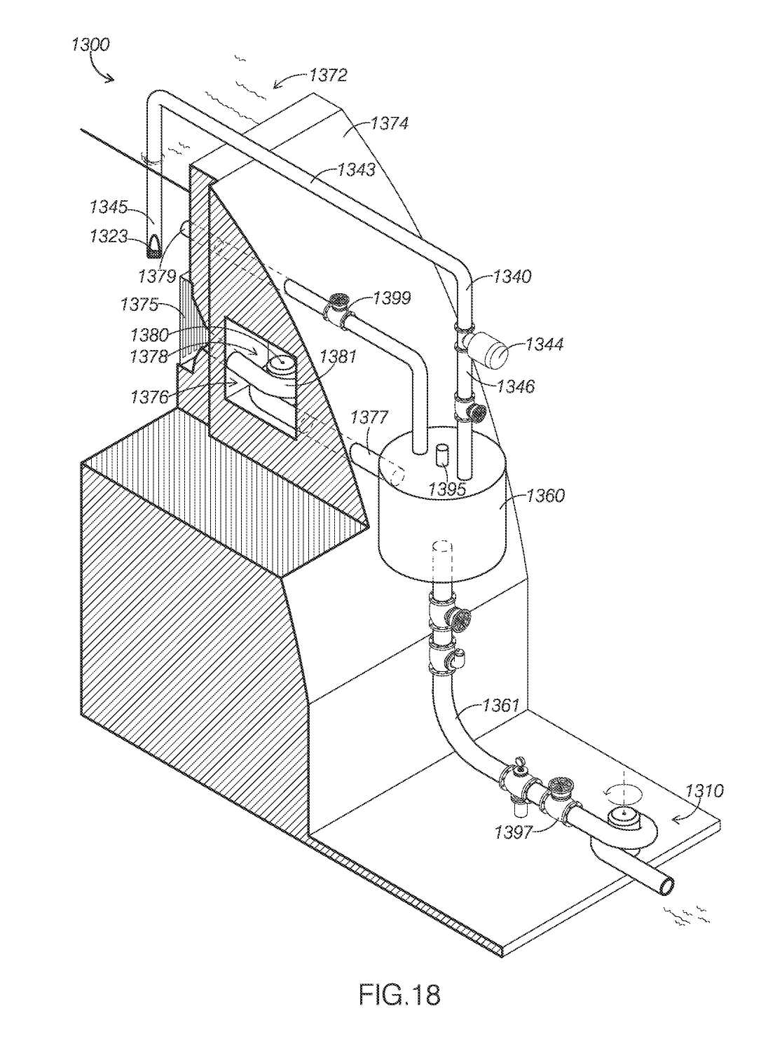

Turning attention to FIG. 18, a fourteenth example of a hydroelectric generator, hydroelectric generator 1300, now be discussed. Hydroelectric generator 1300 shares many similar or identical features with previously disclosed examples of hydroelectric generators that are combined in unique and distinct ways. Thus, for the sake of brevity, each feature of hydroelectric generator 1300 will not be redundantly explained. Rather, key distinctions between hydroelectric generator 1300 and other previously disclosed examples of hydroelectric generators will be described in detail and the reader should reference the discussion above for features substantially similar between the hydroelectric generators.

As illustrated 18, hydroelectric generator 1300 includes a liquid source 1372, a dam 1374, a spillway pipe 13 siphon 1340, a collection body 1360, and a generation unit 1310. Hydroelectric generator 1300 similar to other disclosed hydroelectric generators, is configured to generate electricity by harnessing potential energy from a volume of liquid contained in liquid source 1372 by communicating the liquid to a generation unit 1310 at a lower position. Hydroelectric generator 1300, similar to hydroelectric generator 900, is configured to harness the output of a hydroelectric generator within dam 1374 and from spillway pipe 1379. However, unlike previously disclosed hydroelectric generators, hydroelectric generator 1300 routes the liquid through a relatively higher elevation region defined by siphon 1340 prior to communicating the liquid to generation unit 1310.

As FIG. 18 illustrates, liquid source 1372 defines a volume of liquid representing a source of potential energy due to its higher elevation than generation unit 1310. Liquid source 1372, is not required to contain a specific volume of liquid; rather, hydroelectric generator 1300 is configured to harness the potential energy of liquid contained within liquid source 1372 at various volumes by receiving the liquid via dam 1374, spillway pipe 1379, and/or siphon 1340, acting individually or in concert.

As seen in FIG. 18, dam 1374 is adjacent to liquid source 1372. Dam 1374 includes a dam generator 1376. Dam 1374 impedes liquid source 1372 and collects to a selected volume of liquid. Upon reaching a sufficient volume dam 1374 is configured to feed a selected quantity of the liquid contained within liquid source 1372 through dam generator 1376 to generate electricity.

Dam generator 1376 is a hydroelectric generator positioned within dam 1374. Dam generator 1376 includes a penstock 1375, a dam generation unit 1378, and a internal generator output pipe 1377. Dam generator 1376 is configured to receive liquid from liquid source 1372, feed the liquid through dam generator 1376 to drive dam generation unit 1378 and to generate electricity, and output the liquid to collection body 1360.

Dam generation unit 1378 includes a turbine 1381 and a generator 1380. Dam generator 1376 is configured to feed liquid through dam generation unit 1378 to drive turbine 1381, which is drivingly connected to generator 1380. Penstock 1375 defines a channel between liquid source 1372 and dam generation unit 1378, allowing liquid source 1372 to feed and drive dam generation unit 1378. Penstock 1375 is configured to receive liquid from liquid source 1372 and communicate the liquid to dam generation unit 1378 when liquid source 1372 contains a volume of liquid above a selected minimum volume sufficient to drive dam generation unit 1378.

Internal generator output pipe 1377 is connected on a first end to the output of dam generator 1376 on a first end and to collection body 1360 on a second end. Working in concert, penstock 1375, dam generation unit 1378, and collection body 1360 cooperatively feed liquid through dam generator 1376 to generate electricity and output the liquid to collection body 1360 where it may later be harnessed by generation unit 1310.

Spillway pipe 1379 extends from a first end within liquid source 1372 of a second end connected to collection body 1360. Spillway pipe 1379 includes a spillway valve 1399 positioned proximate its second end. Spillway pipe 1379 configured to selectively direct liquid from liquid source 1372 to collection body 1360. By selectively directing liquid away from liquid source 1372, spillway pipe 1379 may be used to substantially limit the volume of the liquid contained within liquid source 1372 and prevent flooding.

Specifically, spillway pipe 1379 is configured to selectively route liquid from liquid source 1372 to collection body 1360 when the volume of liquid contained in liquid source 1372 exceeds a selected volume, which may substantially prevent flooding in the area surrounding hydroelectric generator 1300. Spillway pipe 1379 may be configured for automatic operation when the volume of liquid source 1372 exceeds the selected value, but may also be configured to be operated manually. Additionally or alternatively, spillway pipe 1379 may receive liquid from liquid source 1372 when liquid source 1372 contains a volume sufficient to reach spillway pipe 1379. Similar to spillway channel 962, spillway pipe 1379 outputs to collection body 1360 so the output liquid may be harnessed for hydroelectric generation by generation unit 1310.

Spillway valve 1399 is positioned proximate the second end of spillway pipe 1379. Spillway valve 1399 is configured to selectively open to alloy liquid to flow from liquid source 1372 through spillway pipe 1379, allowing a user to substantially regulate the volume of liquid source 1372.

As FIG. 18 illustrates, siphon 1340 extends from a first end located within liquid source 1372 to a second end connected to collection body 1360. Siphon 1340 includes a siphon pipe 1342, a primer pump 1344, and a siphon valve 1347. Siphon 1340 is configured to selectively route liquid from liquid source 1372 to collection body 1360, where it may be further harnessed by generation unit 1310.

Siphon pipe 1342 defines a pipe extending over dam 1374 from a first end located within liquid source 1372 to a second end connected to collection body 1360 at a lower elevation than the first end. Siphon pipe 1342 includes an elevated segment 1343 that is higher than both the first end and the second end in elevation. Siphon pipe 1342 includes an input segment 1345 that extends from the first end to elevated segment 1343 and a discharge segment 1346 that extends from elevated segment 1343 to the second end.

Siphon pipe 1342 is configured to receive liquid from liquid source 1372 when there is a sufficient volume of liquid within liquid source 1372 to power dam generator 1376 and also when the volume is insufficient. When there is not a sufficient volume of liquid within liquid source 1372 to power dam generator 1376, the first end of siphon pipe 1342 may be positioned above or below penstock 1375.

Siphon pipe 1342 is configured to move liquid contained within liquid source 1372 to collection body 1360 without requiring external means, such as a pump. Specifically, liquid contained within discharge segment 1346 is discharged into collection body 1360 when the hydrostatic pressure at the inlet of siphon pipe 134 is greater than the pressure of the outlet of siphon pipe 1342.

Siphon pipe 1342 additionally includes screen 1323 positioned on the first end of the siphon pipe. Screen 1323 defines a perforated metal plate including perforations conforming to NOAA standards to maximize flow while minimizing environmental impact. Although screen 1323 defines a perforated metal plate, screens according to this disclosure may include other positive barriers, such as fish handling and return systems, cylindrical wedgewire screens, and fish net barriers. Screens according to this disclosure may include both positive, as described above, and behavioral barriers that encourage fish to swim away from the hydroelectric generator.

Avoiding the need to generate a constant displacement force within siphon pipe 1342 with external means provides additional efficiency gains. Indeed, additional liquid may be harnessed downstream of liquid source 1372. Additionally, siphon 1340 allows a designer to efficiently route liquid from liquid source 1372 to collection body 1360 where the most practical path to route the water requires routing the liquid upwards for a segment of the path.

Additionally, as liquid contained within discharge segment 1346 is drawn into collection body 1360, a partial vacuum is created within input segment 1345, allowing additional liquid to be drawn from liquid source 1372 into siphon pipe 1342. Once fluid communication is initiated between liquid source 1372 and collection body 1360, siphon pipe 1342 continues to draw liquid from liquid source 1372 to collection body 1360 without moving liquid through siphon pipe 1342 by external means. The ability to continuously draw liquid from liquid source 1372 by a self-sustaining suction force and to route the liquid upward for a portion of its length distinguishes siphon 1340 from a simple pipe feeding water to collection body 1360.

Primer pump 1344 is positioned along discharge segment 1346 proximate the second end of siphon pipe 1342. Siphon 1340 not create the partial vacuum necessary to feed liquid into input segment 1345 unless liquid is discharged from discharge segment 1346. As a result, the unassisted communication of liquid from liquid source 1372 to collection body 1360 may not occur unless liquid is already contained within siphon 1340. Primer pump 1344 is configured to selectively apply a displacement force through siphon pipe 1342 to displace liquid contained in liquid source 1372 into discharge segment 1346. Primer pump 1344 is configured to selectively operate until a selected amount of liquid is contained within siphon pipe 1342, at which point siphon 1340 may commence communication of liquid from liquid source 1372 to collection body 1360 without any external force.

Siphon 1340 additionally includes siphon valve 1347 proximate the second end of siphon pipe 1342. Siphon valve 1347 is configured to selectively open to allow liquid flow through siphon pipe 1342. By selectively impending liquid flow within siphon valve 1347, siphon valve 1347 allows a user to retain a volume of liquid within discharge segment 1346, potentially obviating the need to re-prime siphon. 1340 for a subsequent use. Additionally, siphon valve 1347 allows a user to selectively cease siphoning operation.

Collection body 1360 is connected to and receives the output of siphon pipe 1342, internal generator output pipe 1377 and spillway pipe 1379. Collection body 1360 includes a head pipe 1361 and a pressure release pipe 1395. Collection body 1360 receives and collects liquid from internal generator output pipe 1377, siphon pipe 1342, and spillway pipe 1379. Collection body 1360 additionally routes contained liquid to head pipe 1361.

Head pipe 1361 defines a pipe connected on a first end to collection body 1360 and on a second end to generation unit 1310. Head pipe 1361 includes a head pipe valve 1397. Head pipe 1361 is configured to receive liquid from collection body 1360 to collect a selected quantity of the liquid to pressurize the liquid to a selected amount of head pressure prior to sending the liquid to generation unit 1310. Head pipe 1361 is sized to collect a head representing a sufficient amount of potential energy to drive generation unit 1310.

Head pipe 1361 includes head pipe valve 1397 attached proximate its connection with generation unit 1310. Head pipe valve 1397 is configured to selectively impede the flow of liquid from head pipe 1361 to generation unit 1310. Head pipe valve 1397 allows a user to impede the flow of liquid into generation unit 1310 until a sufficient head is generated within head pipe 1361.

Generation unit 1310 is connected to head pipe 1361. Generation unit 1310 includes a turbine and generator arrangement similar to generation unit 110. Generation unit 1310 is similarly configured to receive liquid from head pipe 1361 and use the liquid to drive the turbine and generator to produce electricity.

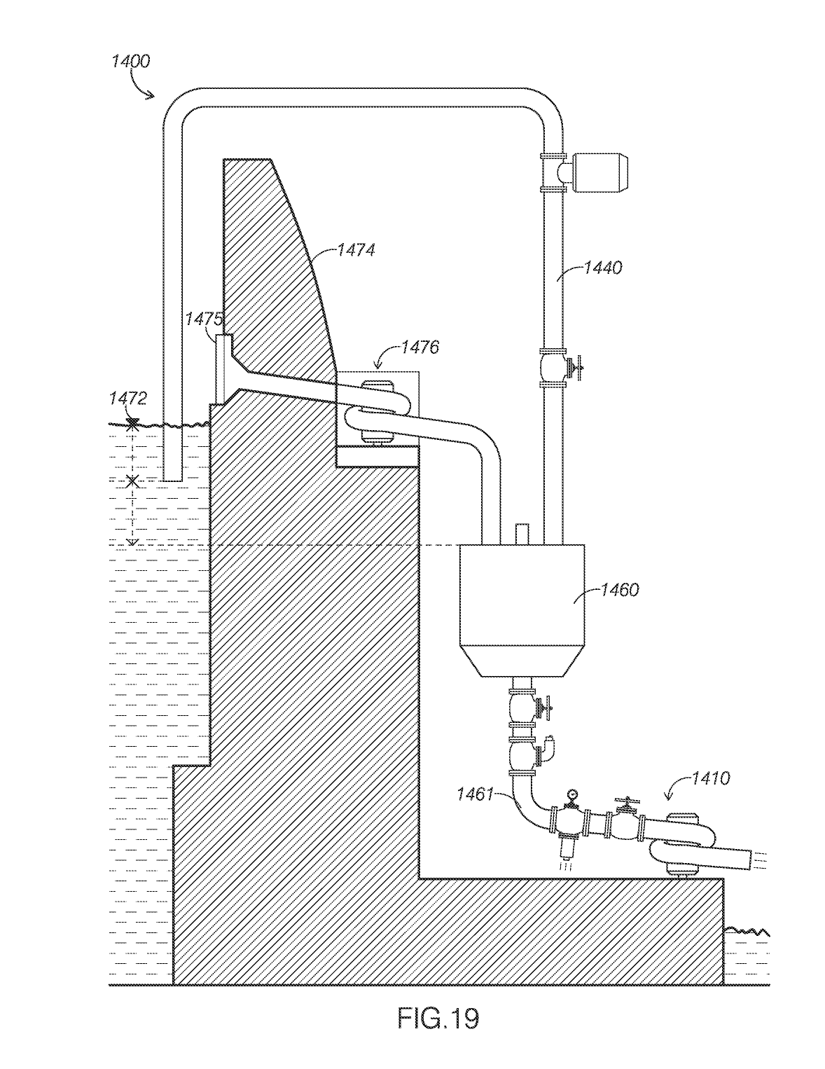

Turning attention to FIG. 19, a fifteenth example of a hydroelectric generator, hydroelectric generator 1400, will now be described. Hydroelectric generator 1400 shares many similar or identical features with previously disclosed examples of hydroelectric generators that are combined in unique and distinct ways. Thus, for the sake of brevity, each feature of hydroelectric generator 1400 not be redundantly explained. Rather, key distinctions between hydroelectric generator 1400 and other previously disclosed examples of hydroelectric generators will be described in detail and the reader should reference the discussion above for features substantially similar between the hydroelectric generators.

As FIG. 19 shows, hydroelectric generator 1400 is similar hydroelectric generator 1300. Specifically, it includes a siphon 1440 routed over a dam 1474 from a liquid source 1472 to a collection body 1460. Also similar to hydroelectric generator 1300, hydroelectric generator 1400 includes a dam generator 1476 configured to receive liquid from liquid source 1472 and to output to collection body 1460. Like hydroelectric generator 1300, hydroelectric generator 1400 routes liquid collected in collection body 1460 to a generation unit 1410 via a head pipe 1461.

A difference between hydroelectric generator 1400 and hydroelectric generator 1300 is the depth at which siphon 1440 extends within liquid source 1472. As FIG. 19 illustrates, dam 1474 includes a penstock 1475, by which liquid is routed from liquid source 1472 to dam generator 1476. Siphon 1440 extends below penstock 1475, whereas siphon 1340 does not.

Because siphon 1440 extends below penstock 1475, hydroelectric generator 1400 is able to siphon liquid from liquid source 1472 to collection body 1460 in conditions where the volume of liquid contained within liquid source 1472 is insufficient to drive dam generator 1476. This allows hydroelectric generator 1400 to produce efficiency gains by generating electricity at times in which a similar hydroelectric generator lacking a siphoning element would be at rest.

Although siphon 1440 extends below penstock 1475, certain hydroelectric generators may be unable to operate due to an insufficient volume of liquid within the liquid source even when the surface level of the liquid is above the dam's penstock. As a result, hydroelectric generators may include siphons that extend to any depth within a liquid source, whether the minimum amount is sufficient to power the dam interior generator or not. By extension, this disclosure specifically contemplates hydroelectric generators that are configured to operate in concert with a internal generator within a dam, separate from the internal generator, and/or both.

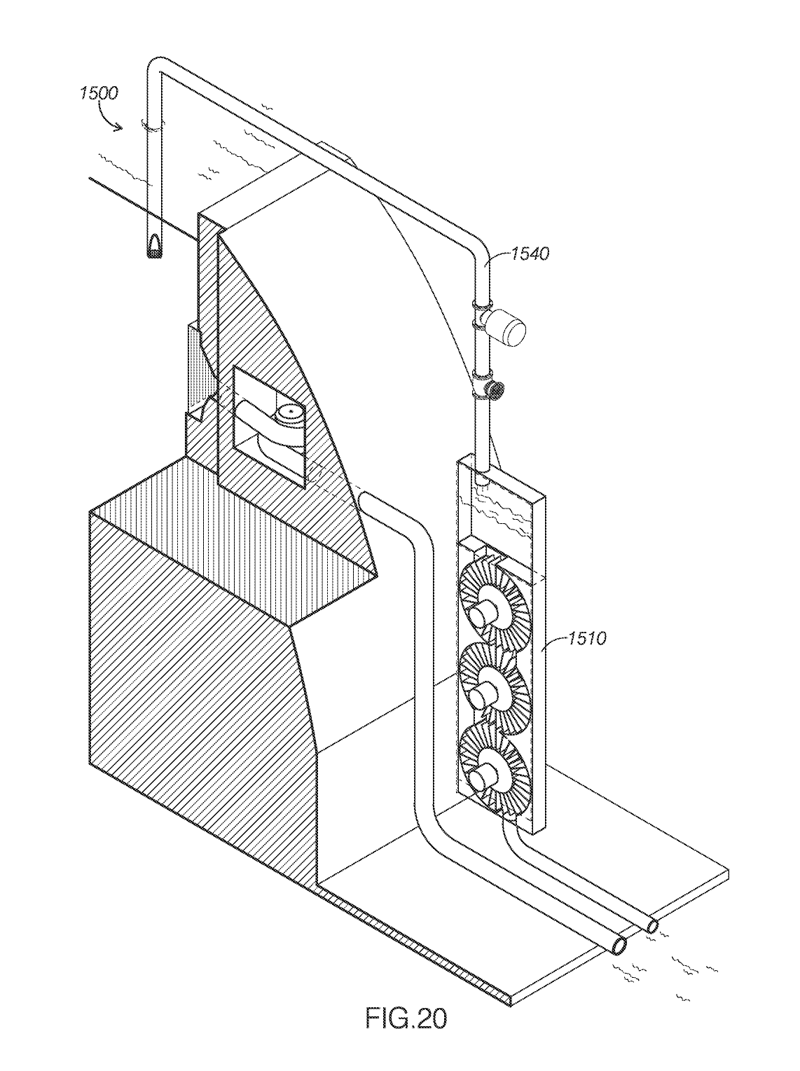

Turning attention to FIG. 20, a sixteenth example of a hydroelectric generator hydroelectric generator 1500, will now be described. Hydroelectric generator 500 shares many similar or identical features with previously disclosed examples of hydroelectric generators that are combined in unique and distinct ways. Thus, for the sake of brevity, each feature of hydroelectric generator 1500 will not be redundantly explained. Rather, key distinctions between hydroelectric generator 1500 and other previously disclosed examples of hydroelectric generators will be described in detail and the reader should reference the discussion above for features substantially similar between the hydroelectric generators.

Hydroelectric generator 1500 includes a siphon 1540 and a generation unit 1510. Hydroelectric generator 1500 is configured to siphon liquid and drive generation unit 1510, similar to hydroelectric generator 1300 and hydroelectric generator 1400. Hydroelectric generator 1500, however, is configured to operate independent of any other hydroelectric generation already occurring within or around the dam. Additionally, hydroelectric generator 1500 includes generation unit 1510 similar to hydroelectric generator 400, which obviates the need for the collection of siphoned liquid to a head prior to feeding the liquid through generation unit 1510.

Siphon 1540 is substantially similar to siphon 1440 and siphon 1340. A difference between siphon 1540 and previous siphons lies in its direct connection to generation unit 1510 without requiring the liquid to first be collected into a collection body and built to a head within a head pipe.

Generation unit 1510 is substantially similar to hydroelectric generator 400, which is a storage turbine hydroelectric generator. A storage turbine hydroelectric generator allows siphon 1540 to discharge directly into generation unit 1510. This allows hydroelectric generator 1500 to operate in low-flow contexts and eliminates the need for collection bodies and head pipes, which may be impractical and/or unsightly in some applications.

FIG. 20 illustrates hydroelectric generator 1500 including a storage turbine hydroelectric generator, but hydroelectric generators including siphons in a similar manner to hydroelectric generator 1500 that include any of the disclosed storage turbine hydroelectric generators are equally within this disclosure.

FIGS. 18-20 specifically illustrate hydroelectric generators using siphoning means in dam contexts. However, the disclosed siphon and generator designs are not specifically limited to use in dam contexts.

Specifically, the disclosed siphon and generator designs may be used in any context where a generator is placed at a lower elevation than a liquid source and there is some benefit to elevating a segment of the siphon pipe. This specifically includes features such as elevated lakes and cascading segments of liquid channels. Often, the aesthetic beauty and the reliance of the surrounding ecosystem on the liquid source precludes harnessing the potential energy in the liquid source with current technologies. However, the siphon-fed generator systems disclosed may provide a less intrusive and/or harmful means of accomplishing this goal.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and on-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those, claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

I claim:

1. A hydroelectric generator, comprising:
a liquid source containing a liquid;
a siphon extending from a first end positioned within the liquid source to a second end at a lower elevation than the first end, the siphon including a siphon pipe including:
an input segment proximate the first end defining an input opening within the liquid source;
a discharge segment proximate the second end defining an output opening; and
an elevated segment extending between the input segment and the discharge segment with a portion of its length above the first end and the second end;
a collection body configured to collect liquid from the discharge segment; and
a generation unit configured to receive liquid from the collection body, including:
a turbine configured to be driven by the liquid; and
a generator drivingly connected to the turbine configured to generate electricity when driven by the turbine.

2. The hydroelectric generator of claim 1, wherein the siphon additionally includes a priming unit configured to apply a displacement force within the siphon pipe directed from the first end to the second end.

3. The hydroelectric generator of claim 1, further comprising a pressure release pipe positioned on the top of the collection body.

4. The hydroelectric generator of claim 1, further comprising:
a dam impeding the liquid source; and
a spillway pipe extending from the liquid source to the collection body;
wherein the siphon pipe is routed over the dam.

5. The hydroelectric generator of claim 4, further comprising:
a spillway pipe valve configured to selectively open the spillway pipe to direct liquid from the liquid source to the collection body.

6. The hydroelectric generator of claim 4, further comprising an internal hydroelectric generation system in the interior of the dam, including:
a penstock configured to receive liquid from the liquid body;
a generation unit configured to selectively receive liquid from the penstock, the generation unit including:
a turbine configured to be driven by the liquid received from the penstock; and
a generator drivingly connected to the turbine configured to generate electricity when driven by the turbine.

7. The hydroelectric generator of claim 6, additionally comprising an internal generator output pipe connected to the internal hydroelectric generation system on a first side and to the collection body on an opposite side, the internal generator output pipe configured to feed the output of the internal hydroelectric generation system to the collection body.

8. The hydroelectric generator of claim 6, wherein the liquid source contains a volume of liquid insufficient selected to power the internal hydroelectric generation system; and
wherein the first end of the input pipe is positioned within the volume of liquid.

9. The hydroelectric generator of claim 8, wherein the first end of input pipe is positioned below the penstock.

10. The hydroelectric generator of claim 8, wherein the first end of the input pipe is positioned above the penstock.

11. The hydroelectric generator of claim 1, further comprising a head pipe in fluid communication with the collection body, the head pipe configured to collect a selected quantity of liquid from the collection body to pressurize the liquid to a selected amount of head pressure prior to sending the pressurized liquid to the generation unit.

12. The hydroelectric generator of claim 1, wherein the siphon pipe additionally includes a valve that selectively opens to allow liquid to flow through the siphon pipe.

13. The hydroelectric generator of claim 1, wherein the generation unit is a storage turbine hydroelectric generator.

14. The hydroelectric generator of claim 1, wherein the liquid source is configured to collect the output of a hydroelectric generator.

15. The hydroelectric generator of claim 1, wherein the liquid source defines a volume of liquid contained within a natural basin.

16. The hydroelectric generator of claim 1, wherein the generation unit is configured to output to a natural watercourse.

17. The hydroelectric generator of claim 1, further comprising a screen positioned on the first end of the siphon pipe.

18. A hydroelectric generator, comprising:
a liquid source containing a liquid;
an siphon pipe defining a first end configured to receive liquid from the liquid source, extending to a second end below the first end, and defining an interior configured to route the received liquid from the first end to the second end;
a priming unit attached to the siphon pipe configured to selectively displace the liquid contained within the interior of the input pipe;
a collection body positioned below the liquid source in fluid communication with the siphon pipe;
a first turbine positioned below the collection body;
a plurality of first turbine blades extending radially around the first turbine, the first turbine blades defining a plurality of first turbine collection bodies in the spaces between adjacent first turbine blades;
a first generator drivingly connected to the first turbine, the first generator being configured to generate electrical energy when driven by rotation of the first turbine; and
a first output positioned below the first turbine;
wherein the first turbine collection bodies are configured to collect a volume of liquid from the collection body;
wherein the collected volume of liquid applies a torque to the first turbine, causing the first turbine to rotate; and
wherein the volume of liquid is expelled through the first output as the first turbine rotates.

19. The hydroelectric generator of claim 17, further comprising:
a second turbine configured to receive a volume of liquid from the first output and configured to rotate in an opposite direction from the first turbine;
a plurality of second turbine blades extending radially around the second turbine and defining a plurality of second turbine collection bodies in the space between adjacent second turbine blades;
a second generator drivingly connected to the second turbine, configured to generate electrical energy as the second turbine rotates; and
wherein the second turbine collection bodies are configured to collect a volume of liquid from the liquid source and;
the volume of liquid applies a torque to the second turbine, causing the second turbine to rotate.

20. A hydroelectric generator, comprising:
a liquid source containing a liquid;
a siphon, including:
an siphon pipe extending from a first end to a second end at a lower elevation than the first end, the input pipe including:
an input segment proximate the first end defining an input opening within the liquid source;
a discharge segment proximate the second end defining an output opening; and
an elevated segment extending between the input segment and the discharge segment, the elevated segment at a higher elevation than the first end and the second end; and
a collection body positioned below the liquid source in fluid communication with the siphon, the collection body configured to collect liquid from the output opening; and
a generation unit configured to receive liquid from the collection body, including:
a turbine configured to be driven by the liquid to generate electricity; and
generator drivingly connected to the turbine configured to generate electricity when driven by the turbine;
wherein the pressure as the output opening of the discharge segment is less than the pressure at the input opening of the input segment when the input segment is substantially filled with a selected liquid.
